(19) United States
(12) Patent Application Publication
(10) Pub. No.: US 2026/0097386 A1
(43) Pub. Date: Apr. 9, 2026

(54) MULTI-NANOCOMPOSITE FOR WATER DECONTAMINATION

(71) Applicant: KING FAHD UNIVERSITY OF PETROLEUM AND MINERALS, Dhahran (SA)

(72) Inventors: Sagheer A. ONAIZI, Dhahran (SA); Salem A. BAHADI, Dhahran (SA)

(73) Assignee: KING FAHD UNIVERSITY OF PETROLEUM AND MINERALS, Dhahran (SA)

(21) Appl. No.: 18/912,414

(22) Filed: Oct. 10, 2024

(30) Foreign Application Priority Data
Oct. 7, 2024 (SA) 1020245626

(51) Int. Cl. B01J 20/20; B01J 20/08; B01J 20/12; B01J 20/28; B01J 20/30; C02F 1/28; C02F 101/30

(52) U.S. Cl. CPC B01J 20/205; B01J 20/08; B01J 20/12; B01J 20/28007; B01J 20/2803; B01J 20/28059; B01J 20/28061; B01J 20/28071; B01J 20/28083; B01J 20/3042; B01J 20/3071; B01J 20/3085; C02F 1/288; C02F 1/281; C02F 1/283; C02F 1/285; C02F 2101/308; C02F 2303/16

(57) ABSTRACT

A carbon nanocomposite sorbent useful for removing organic pollutants from water. The nanocomposite sorbent includes a carbon nanomaterial polymer composite including polyethyleneimine and a carbon nanomaterial, a smectite clay and a layered triple hydroxide that includes a first metal, a second metal, and a third metal. A method of fabrication of the nanocomposite sorbent. The nanocomposite sorbent is used in a method of removing an organic pollutant from water.

### CROSS-REFERENCE TO RELATED APPLICATIONS

The present disclosure claims the benefit of Saudi Patent Application No. 1020245626 filed on Oct. 7, 2024, with the Saudi Authority for Intellectual Property Office, which is incorporated herein by reference in its entirety.

### BACKGROUND OF THE INVENTION

### Field of the Invention

The present disclosure is directed to a nanocomposite sorbent, particularly a carbon nanocomposite derived from a carbon nanomaterial, polyethyleneimine, smectic clay, and a layered triple hydroxide.

### Description of Related Art

The “background” description provided herein is for the purpose of generally presenting the context of the disclosure. Work of the presently named inventors, to the extent it is described in this background section and aspects of the description which may not otherwise qualify as prior art at the time of filing, are neither expressly nor impliedly admitted as prior art against the present invention.

Water contamination can occur from a wide variety of organic substances from a diverse array of sources, including pesticides/insecticides used in agriculture, industrial chemicals, dyes, that find their way to water bodies, overflowing sewers, and more. Wastewater created as a byproduct of industrial textile production is of great concern because it contains a variety of toxic organic dyes that can lead to severe human health impacts such as leukemia, brain disorders, various life-threatening allergies, and cancer. Removing or degrading such dyes is very difficult using conventional treatment methods due to factors which make them attractive for use as dyes such as low biodegradability and high dissolubility.

Two common dyes that cause detrimental water contamination include methyl orange (MO) and crystal violet (CV). MO is a member of azo dyes commonly used as synthetic dyes in textile, food, paper, and cosmetics. Its use is easy and cost-effective compared with natural dyes. However, azo dyes are typically difficult to remove because of their high water solubility. Crystal violet is a cationic, tri-phenyl-methane dye responsible for causing eye, skin, and digestive tract irritation. It can disrupt the mitotic division of cells; hence, it is carcinogenic and can cause a potential biohazard.

Various methods have been developed for the removal of organic contaminants, including coagulation, ion exchange, chemical precipitation, electrochemical methods, reverse osmosis, and membrane processes [See: Mahmud, H. N. M. E., Huq, A. O., & binti Yahya, R. (2016). The removal of heavy metal ions from wastewater/aqueous solution using polypyrrole-based adsorbents: a review. RSC Advances, 6(18), 14778-14791]. However, most of these techniques suffer from crucial shortcomings, such as high capital and operational costs, inadequate efficiencies at usual discharge levels, and the occurrence of secondary pollution. As opposed to the above limitations, adsorption has become a valuable alternative owing to the low cost of adsorbent materials, lower working costs, feasible operational conditions, high efficacy for dilute solutions, and easy handling. Furthermore, adsorption is usually reversible; thus, the adsorbents can be regenerated using an appropriate desorption method. Currently used adsorbents are unsuitable for removing all kinds of contaminants and pollutants from water, such as methyl orange and crystal violet.

Accordingly, one object of the present disclosure is to provide a water decontamination technique that is capable of filtering out a wide range of organic contaminants, particularly organic pollutants difficult to remove using conventional techniques such as methyl orange and crystal violet, from the water while being cost-effective and environmentally friendly.

### SUMMARY

In an exemplary embodiment, a nanocomposite sorbent is described. The nanocomposite sorbent comprises a carbon nanomaterial polymer composite that includes polyethyleneimine, a carbon nanomaterial, a smectite clay, and a layered triple hydroxide made up of a first metal, a second metal, and a third metal.

In some embodiments, the carbon nanomaterial is graphene oxide.

In some embodiments, the carbon nanomaterial polymer composite has a weight ratio of polyethyleneimine to carbon nanomaterial of 1:5 to 1:15.

In some embodiments, the smectite clay is bentonite.

In some embodiments, a weight ratio of the carbon nanomaterial polymer composite to the smectite clay of 2.5:1 to 1:2.5.

In some embodiments, the nanocomposite sorbent has 12.5 to 15 atom % carbon, 12.5 to 15.0 atom % the first metal, 5.0 to 10.0 atom % the second metal, 0.25 to 2.5 atom % the third metal, 4.0 to 9.0 atom % silicon.

In some embodiments, the nanocomposite sorbent has a ratio of the first metal to a total of the second metal and the third metal of 1.00:1 to 2.00:1 by atom %, and a ratio of carbon to nitrogen of 3.5:1 to 5.0:1 by atom %.

In some embodiments, the layered triple hydroxide is present as particles that has a mean particle size of 10 to 50 nanometers (nm).

In some embodiments, the carbon nanomaterial is graphene oxide and is present as flakes having 2 to 10 layers of graphene oxide.

The present disclosure also relates to a method of forming the nanocomposite sorbent. The method includes dispersing the carbon nanomaterial polymer composite and smectite clay in water to form a first mixture; and adding the base solution to a base solution. The base mixture and a metal solution comprising the first metal, the second metal, and the third metal form a reaction mixture. The method further includes aging the reaction mixture for 8 to 36 hours to form a crude product, and washing the crude product is washed to form the nanocomposite sorbent.

In some embodiments, the method also includes forming the carbon nanomaterial polymer composite. The forming the carbon nanomaterial polymer composite includes mixing the carbon nanomaterial, a base, and the polyethyleneimine in water to form a precursor mixture; and heating the precursor mixture to 75 to 105° C. for 12 to 48 hours to form the carbon nanomaterial polymer composite.

In some embodiments, the first metal, the second metal, and the third metal are each present as a salt selected from a nitrate salt, a sulfate salt, a halide salt, an acetate salt, and a formate salt.

In some embodiments, the first metal is magnesium, the second metal is iron, and the third metal is aluminum.

In some embodiments, the metal solution comprises magnesium nitrate, iron (III) nitrate, and aluminum nitrate.

In some embodiments, the base mixture comprises an alkali metal or alkaline earth metal carbonate and an alkali metal or alkaline earth metal hydroxide.

In some embodiments, the base solution, the metal solution are each an aqueous solution.

The present disclosure also relates to a method of removing an organic pollutant from water. The method includes contacting water containing an organic pollutant with the nanocomposite sorbent. The method further includes recovering the nanocomposite sorbent and optionally eluting the organic pollutant from the nanocomposite sorbent. The organic pollutant is at least one selected from the group consisting of a dye, a phenol, a polycyclic aromatic hydrocarbon, an herbicide, a pesticide, and a persistent organic pollutant.

In some embodiments, the method further includes eluting the organic pollutant from the nanocomposite sorbent by washing with a wash solvent.

In some embodiments, the method removes 750 to 1100 mg methyl orange per gram of nanocomposite sorbent at a pH of 2 to 4 and 425 to 650 mg crystal violet per gram of nanocomposite sorbent at a pH of 6 to 8.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawing, wherein:

FIG. 1A is a flowchart of a method of forming a nanocomposite sorbent, according to certain embodiments.

FIG. 1B is a flowchart of a method of forming a carbon nanomaterial polymer composite, according to certain embodiments.

FIG. 1C is a flowchart of a method of removing an organic pollutant from water, according to certain embodiments.

FIG. 2 shows X-ray diffraction (XRD) patterns of various nanocomposites and their parental materials, according to certain embodiments.

FIG. 3A-FIG. 3D show adsorption and desorption isotherms of nitrogen onto various nanocomposites and their parental materials, according to certain embodiments.

FIG. 4A shows Fourier Transform Infrared (FTIR) spectra of graphene oxide (GO), according to certain embodiments.

FIG. 4B shows FTIR spectra of functionalized graphene oxide (AGO), according to certain embodiments.

FIG. 4C shows FTIR spectra of bentonite, according to certain embodiments.

FIG. 4D shows FTIR spectra of layered triple hydroxide (MgFeAl-LTH), according to certain embodiments.

FIG. 4E shows FTIR spectra of GO/MgFeAl-LTH, according to certain embodiments.

FIG. 4F shows FTIR spectra of AGO/MgFeAl-LTH, according to certain embodiments.

FIG. 4G shows FTIR spectra of bentonite/MgFeAl-LTH, according to certain embodiments.

FIG. 4H shows FTIR spectra of GO/bentonite, according to certain embodiments.

FIG. 4I shows FTIR spectra of AGO/bentonite, according to certain embodiments.

FIG. 4J shows FTIR spectra of AGO/bentonite/MgFeAl-LTH nanocomposite, according to certain embodiments.

FIG. 5A shows a scanning electron microscope (SEM) image of GO, according to certain embodiments.

FIG. 5B shows a SEM image of AGO, according to certain embodiments.

FIG. 5C shows a SEM image of bentonite according to certain embodiments.

FIG. 5D shows a SEM image of MgFeAl-LTH, according to certain embodiments.

FIG. 5E shows a SEM image of GO/MgFeAl-LTH, according to certain embodiments.

FIG. 5F shows a SEM image of AGO/MgFeAl-LTH, according to certain embodiments.

FIG. 5G shows a SEM image of bentonite/MgFeAl-LTH, according to certain embodiments.

FIG. 5H shows a SEM image of GO/bentonite, according to certain embodiments.

FIG. 5I shows a SEM image of AGO/bentonite, according to certain embodiments.

FIG. 5J shows a SEM image of AGO/bentonite/MgFeAl-LTH nanocomposite, according to certain embodiments.

FIG. 6 shows the adsorption of crystal violet (CV) and methyl orange (MO) onto various nanocomposites, according to certain embodiments.

FIG. 7 shows zeta potential analysis for determining the point of zero charge (pHpzc) of various nanocomposites, according to certain embodiments.

FIG. 8 shows the effect of pH on the adsorption of CV and MO onto AGO/Bentonite/MgFeAl-LTH adsorbent, according to certain embodiments.

FIG. 9 shows the reusability of the AGO/Bentonite/MgFeAl-LTH nanocomposite, according to certain embodiments.

### DETAILED DESCRIPTION OF THE INVENTION

In the drawings, reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, the term ‘alkali metal carbonate’ refers to a compound composed of an alkali metal cation (such as lithium, sodium, potassium, rubidium, cesium, or francium) combined with carbonate ions. Alkali metal carbonates are typically white, crystalline solids that are soluble in water. They are strong bases and react with acids to form salts and carbon dioxide. Examples include sodium carbonate and potassium carbonate.

As used herein, the term ‘alkaline earth metal carbonate’ refers to the compound composed of an alkaline earth metal cation (such as beryllium, magnesium, calcium, strontium, barium, or radium) combined with carbonate ions. Alkaline earth metal carbonates are also white, crystalline solids that are sparingly soluble in water. They react with acids to form salts, carbon dioxide, and water. Examples include calcium carbonate and magnesium carbonate.

As used herein, the term ‘alkali metal hydroxide’ refers to the compound composed of an alkali metal cation combined with a hydroxide ion. Alkali metal hydroxides are strong bases and highly soluble in water. They are corrosive and have a caustic effect on organic matter. Alkali metal hydroxides dissociate completely in water to produce hydroxide ions and the corresponding metal cation. Examples include sodium hydroxide (NaOH) and potassium hydroxide (KOH).

As used herein, the term ‘alkaline earth metal hydroxide’ refers to the compound composed of an alkaline earth metal cation combined with a hydroxide ion. Alkaline earth metal hydroxides are strong bases but less soluble in water compared to alkali metal hydroxides. They also dissociate in water to produce hydroxide ions and the corresponding metal cation. Examples include calcium hydroxide and barium hydroxide.

Methyl Orange (MO) is an azo dye with the chemical formula C₁₄H₁₄N₃NaO₃S, commonly used as an indicator in titrations due to its distinctive color change properties from orange-red under acidic conditions to yellow in alkaline environments. MO is widely employed in industries such as textiles, leather processing, and paper manufacturing, contributing to its presence as an organic pollutant in wastewater streams.

Crystal Violet (CV), or gentian violet or methyl violet 10B, is a triarylmethane dye with the chemical formula C₂₅H₃₀CLN₃. It is utilized extensively as a histological stain in biological and medical laboratories, as well as in the textile industry for dyeing silk and wool. CV poses environmental concerns due to its toxicological effects on aquatic organisms and its persistence in water systems, necessitating effective treatment methods for its removal from contaminated water sources.

According to a first aspect, the present disclosure relates to a nanocomposite sorbent. The nanocomposite sorbent includes a carbon nanomaterial polymer composite.

Examples of suitable polymers which can be included in the carbon nanomaterial polymer composite include, but are not limited to polyvinylamine (PVA), polyamidoamine (PAMAM) dendrimers, polyethyleneglycol (PEG), polypropylenimine (PPI), poly(N-vinylpyrrolidone) (PVP), and polyethyleneimine (PEI). In some embodiments, the carbon nanomaterial polymer composite includes polyethyleneimine. In some embodiments, the polyethyleneimine may include polyethyleneimine and another polymer.

The carbon nanomaterial polymer composite further includes a carbon nanomaterial. In general, the carbon nanomaterial may be any suitable carbon nanomaterial known to one of ordinary skill in the art. Examples of carbon nanomaterials include carbon nanotubes, carbon nanobuds, carbon nanoscrolls, carbon dots, activated carbon, carbon black, graphene, graphene oxide, reduced graphene oxide, and nanodiamonds. In some embodiments, the carbon nanomaterial is at least one selected from the group consisting of graphene, graphene oxide, reduced graphene oxide, carbon nanotubes, carbon dots, and activated carbon.

In some embodiments, the carbon nanomaterial is carbon nanotubes. The carbon nanotubes may, in general, be any suitable carbon nanotubes known to one of ordinary skill in the art. Carbon nanotubes may be classified by structural properties such as the number of walls or the geometric configuration of the atoms that make up the nanotube. Classified by their number of walls, the carbon nanotubes can be single-walled carbon nanotubes (SWCNT), which have only one layer of carbon atoms arranged into a tube, or multi-walled carbon nanotubes (MWCNT), which have more than one single-layer tube of carbon atoms arranged so as to be nested, one tube inside another, each tube sharing a common orientation. Closely related to MWNTs are carbon nanoscrolls. Carbon nanoscrolls are structures similar in shape to a MWCNT but made of a single layer of carbon atoms that has been rolled onto itself to form a multi-layered tube with a free outer edge on the exterior of the nanoscroll and a free inner edge on the interior of the scroll and open ends. The end-on view of a carbon nanoscroll has a spiral-like shape. For the purposes of this disclosure, carbon nanoscrolls are considered a type of MWCNT. Classified by the geometric configuration of the atoms that make up the nanotube, carbon nanotubes can be described by a pair of integer indices n and m. The indices n and m denote the number of unit vectors along two directions in the honeycomb crystal lattice of a single layer of carbon atoms. If m=0, the nanotubes are called zigzag type nanotubes. If n=m, the nanotubes are called armchair-type nanotubes. Otherwise, they are called chiral-type nanotubes. In some embodiments, the carbon nanotubes are metallic. In other embodiments, the carbon nanotubes are semiconducting. In some embodiments, the carbon nanotubes are SWCNTs. In other embodiments, the carbon nanotubes are MWCNTs. In some embodiments, the carbon nanotubes are carbon nanoscrolls. In some embodiments, the carbon nanotubes are zigzag-type nanotubes. In alternative embodiments, the carbon nanotubes are armchair-type nanotubes. In other embodiments, the carbon nanotubes are chiral-type nanotubes.

In some embodiments, the carbon nanomaterial is graphene. In some embodiments, the carbon nanomaterial is graphene nanosheets. Graphene nanosheets may consist of stacks of graphene sheets with an average thickness and a diameter. In some embodiments, the stacks include 1 to 60 sheets of graphene, preferably 2 to 55 sheets of graphene, preferably 3 to 50 sheets of graphene.

In some embodiments, the graphene is in the form of graphene particles. The graphene particles may have a spherical shape or may be shaped like blocks, flakes, ribbons, discs, granules, platelets, angular chunks, rectangular prisms, or some other shape. In some embodiments, the graphene particles may be substantially spherical, meaning that the distance from the graphene particle centroid (center of mass) to anywhere on the graphene outer surface varies by less than 30%, preferably by less than 20%, more preferably by less than 10% of the average distance. In some embodiments, the graphene particles may be in the form of agglomerates.

In some embodiments, the graphene is pristine. Pristine graphene refers to graphene that has not been oxidized or otherwise functionalized. Pristine graphene may be obtained by exfoliation, chemical vapor deposition synthesis, opening of carbon nanotubes, unrolling of carbon nanoscrolls, and the like. In alternative embodiments, the graphene is functionalized graphene. Functionalized graphene is distinguished from pristine graphene by the presence of functional groups on the surface or edge of the graphene that contain elements other than carbon and hydrogen. In other alternative embodiments, the graphene is graphene oxide. Graphene oxide refers to graphene that has various oxygen-containing functionalities that are not present in pristine graphene. Examples of such oxygen-containing functionalities include epoxides, carbonyl, carboxyl, and hydroxyl functional groups. Graphene oxide is sometimes considered to be a type of functionalized graphene.

In other alternative embodiments, the graphene is reduced graphene oxide. Reduced graphene oxide (rGO) refers to graphene oxide that has been chemically reduced. It is distinct from graphene oxide in it contains substantially fewer oxygen-containing functionalities compared to graphene oxide, and it is distinct from pristine graphene by the presence of oxygen-containing functionalities and structural defects in the carbon network. Reduced graphene oxide is sometimes considered to be a type of functionalized graphene. In preferred embodiments, the carbon nanomaterial is reduced graphene oxide. The reduced graphene oxide may exist as nanosheets, particles having a spherical shape, or may be shaped like blocks, flakes, ribbons, discs, granules, platelets, angular chunks, rectangular prisms, or some other shape as described above, agglomerates as described above, or any other shape known to one of ordinary skill in the art.

In some embodiments, the carbon nanoparticles are activated carbon. Activated carbon is a form of porous carbon with a semi-crystalline, semi-graphitic structure and a large surface area. Activated carbon may be in the form of particles or particulate aggregates having micropores and/or mesopores. Activated carbon typically has a surface area of approximately 500 to 5000 m²/g. The activated carbon particles may have a spherical shape or be shaped like sheets, blocks, flakes, ribbons, discs, granules, platelets, angular chunks, rectangular prisms, or other shapes. In some embodiments, the activated carbon particles may be substantially spherical, meaning that the distance from the activated carbon particle centroid (center of mass) to anywhere on the activated carbon particle outer surface varies by less than 30%, preferably by less than 20%, more preferably by less than 10% of the average distance.

In some embodiments, the carbon nanoparticles are carbon black. Carbon black refers to having a semi-crystalline, semi-graphitic structure, and a large surface area. Carbon black may be distinguished from activated carbon by a comparatively lower surface area, typically 15 to 500 m²/g for carbon black. Additionally, carbon black may lack the requisite micropores and mesopores of activated carbon. The carbon black particles may have a spherical shape or be shaped like sheets, blocks, flakes, ribbons, discs, granules, platelets, angular chunks, rectangular prisms, or other shapes.

In some embodiments, the particles of a carbon nanomaterial are a single type of particle as described above. In this context, “a single type of particle” may refer to particles of a single carbon nanomaterial, particles which have substantially the same shape, particles which have substantially the same size, or any combination of these. In alternative embodiments, mixtures of types of particles are used.

In some embodiments, the carbon nanomaterial is graphene oxide. In some embodiments, the carbon nanomaterial is graphene oxide and is present as flakes having 2 to 10 layers of graphene oxide.

In some embodiments, the carbon nanomaterial may exist in various morphological shapes, such as rods, spheres, wires, crystals, rectangles, triangles, pentagons, hexagons, prisms, disks, cubes, ribbons, blocks, beads, toroids, discs, barrels, granules, whiskers, foils, powders, boxes, stars, tetrapods, belts, flowers, etc. and mixtures thereof. In some embodiments, the carbon nanomaterial is present in the form of sheets having a mean thickness of 50 to 500 nm, preferably 60 to 475 nm, preferably 75 to 450 nm, preferably 100 to 425 nm, preferably 110 to 400 nm, preferably 125 to 375 nm, preferably 150 to 350 nm and a mean width of 500 to 5000 nm, preferably 550 to 4750 nm, preferably 600 to 4500 nm, preferably 650 to 4250 nm, preferably 700 to 4000 nm, preferably 750 to 3900 nm, preferably 800 to 3800 nm, preferably 850 to 3700 nm, preferably 900 to 3600 nm, preferably 950 to 3500 nm, preferably 1000 to 3400 nm.

In some embodiments, the sheets have a monodisperse thickness, having a coefficient of variation or relative standard deviation, expressed as a percentage and defined as the ratio of the sheet thickness standard deviation (a) to the sheet thickness mean (p), multiplied by 100%, of less than 25%, preferably less than 10%, preferably less than 8%, preferably less than 6%, preferably less than 5%. In a preferred embodiment, the sheets have a monodisperse thickness, having a size distribution ranging from 80% of the average thickness to 120% of the average thickness, preferably 85 to 115%, preferably 90 to 110% of the average thickness. In another embodiment, the sheets do not have a monodisperse thickness. In some embodiments, the sheets have a monodisperse diameter, having a coefficient of variation or relative standard deviation, expressed as a percentage and defined as the ratio of the sheet diameter standard deviation (a) to the sheet diameter mean (p), multiplied by 100%, of less than 25%, preferably less than 10%, preferably less than 8%, preferably less than 6%, preferably less than 5%. In a preferred embodiment, the sheets have a monodisperse diameter, having a size distribution ranging from 80% of the average diameter to 120% of the average diameter, preferably 85 to 115%, preferably 90 to 110% of the average diameter. In another embodiment, the sheets do not have a monodisperse diameter.

In some embodiments, the carbon nanomaterial polymer composite has a weight ratio of polyethyleneimine to carbon nanomaterial of 1:5 to 1:15, preferably 1:6 to 1:14, preferably 1:7 to 1:13, preferably 1:8 to 1:12, preferably 1:8.5 to 1:11.5, preferably 1:9 to 1:11, preferably 1:9.25 to 1:10.75, preferably 1:9.5 to 1:10.5, preferably 1:9.75 to 1:10.25, preferably 1:9.9 to 1:10.1, preferably 1:10.

The nanocomposite sorbent further includes a smectite clay. The smectite clay may include, but is not limited to, montmorillonite, hectorite, bentonite, saponite, nontronite. Smectite is the name used for a group of phyllosilicate mineral species, such as montmorillonite, beidellite, nontronite, saponite and hectorite. These and several other less common species are differentiated by variations in chemical composition involving substitutions of Al for Si in tetrahedral cation sites and Al, Fe, Mg and Li in octahedral cation sites. Smectite clays have a variable net negative charge, which is balanced by Na, Ca, Mg and/or H adsorbed externally on interlamellar surfaces. The structure, chemical composition, exchangeable ion type and small crystal size of smectite clays are responsible for several unique properties, including a large chemically active surface area, a high cation exchange capacity, interlamellar surfaces having unusual hydration characteristics, and sometimes the ability to modify strongly the flow behavior of liquids. Natural smectite clays are sometimes divided into three categories, Na smectites, Ca—Mg smectites and Fuller's or acid earths.

In some embodiments, the smectite clay includes montmorillonite. Montmorillonite is a subclass of smectite, a 2:1 phyllosilicate mineral characterized as having greater than 50% octahedral charge; its cation exchange capacity is due to isomorphous substitution of Mg for Al in the central alumina plane. The substitution of lower valence cations in such instances leaves the nearby oxygen atoms with a net negative charge that can attract cations. In a preferred embodiment, the smectite clay is bentonite.

The nanocomposite sorbent also includes a layered triple hydroxide, which includes a first metal, a second metal, and a third metal. Layered triple hydroxides are part of a more general group of layered hydroxides. Layered hydroxides are a class of ionic solids characterized by a layered structure with the generic layer sequence [AcBZAcB]ₙ, where c represents layers of metal cations, A and B are layers of hydroxide (HO⁻) anions, and Z are layers of other anions and neutral molecules (such as water). Lateral offsets between the layers may result in longer repeating periods. Layered hydroxides can be seen as derived from hydroxides of divalent cations with the brucite layer structure [AdBAdB]ₙ, by oxidation or cation replacement in the metal layers (d), so as to give them an excess positive electric charge; and intercalation of extra anion layers (Z) between the hydroxide layers (A,B) to neutralize that charge, resulting in the structure [AcBZAcB]ₙ. Layered hydroxides may be formed with a wide variety of anions in the intercalated layers (Z), such as dodecyl sulfate (DDS) (CH₃(CH₂)₁₁OSO₃⁻), Cl⁻, Br⁻, nitrate (NO₃⁻), carbonate (CO₃²⁻), SO₄²⁻, acetate (C₂H₃O²⁻), SeO₄²⁻, and combinations thereof. The size and properties of the intercalated anions may have an effect on the spacing of the layers, known as the basal spacing.

A layered hydroxide may be a synthetic or a naturally occurring layered hydroxide. Naturally-occurring layered hydroxides include those in the Hydrotalcite Group (hydrotalcite, pyroaurite, stichtite, meixnerite, iowaite, droninoite, woodallite, desautelsite, takovite, reevesite, or jamborite), the Quintinite Group (quintinite, charmarite, caresite, zaccagnaite, chlormagaluminite, or comblainite), the Fougerite group (fougerite, trbeurdenite, or mossbauerite), the Woodwardite Group (woodwardite, zincowoodwardite, or honessite), the Glaucocerinite Group (glaucocerinite, hydrowoodwardite, carrboydite, hydrohonessite, mountkeithite, or zincaluminite), the Wermlandite Group (wermlandite, shigaite, nikischerite, motukoreaite, natroglaucocerinite, or karchevskyite), the Cualstibite Group (cualstibite, zincalstibite, or omsite), the Hydrocalumite Group (hydrocalumite or kuzelite), or may be an unclassified layered hydroxide, such as coalingite, brugnatellite, or muskoxite.

In some embodiments, the first metal, the second metal, and the third metal each independently may include, but are not limited to, iron, copper, aluminum, gold, silver, lead, zinc, nickel, tin, mercury, titanium, platinum, palladium, cobalt, chromium, magnesium, beryllium, cadmium, tungsten, manganese, vanadium, gallium, bismuth, antimony, rhodium. In some embodiments, the first metal is magnesium. In some embodiments, the second metal is iron. In some embodiments, the third metal is aluminum.

In some embodiments, the layered triple hydroxide is present as particles having a mean particle size of 10 to 70 nm. In some embodiments, the layered hydroxide component may have a particulate form, for example in the form of spheres, granules, whiskers, sheets, flakes, plates, foils, fibers, and the like. In some embodiments, the layered triple hydroxide includes particles having an average size of 10 to 70 nm, or preferably 15 to 65 nm, preferably 20 to 60 nm, preferably 25 to 55 nm, preferably 30 to 50 nm, preferably 35 to 45 nm. In some embodiments, the layered triple hydroxide particles are in the form of plates, or nanoplatelets due to their small size. The nanoplatelets may be substantially round or oval shaped nanoplatelets or, alternatively, the nanoplatelets may be polygonal nanoplatelets, such as triangular, square, rectangular, pentagonal, hexagonal, star-shaped, and the like. In some embodiments, the layered triple hydroxide particles are in the form of hexagonal nanoplatelets with particle sizes stated above. Such nanoplatelets may have a thickness of less than 10 nm, preferably less than 8 nm, preferably less than 6 nm, preferably less than 4 nm. In some embodiments, the layered hydroxide has a basal spacing of 0.5 to 10 nm, preferably 1 to 9 nm, 2 to 8 nm, 3 to 7 nm, 4 to 6 nm, or 4.5 to 5.5 nm.

In some embodiments, the nanocomposite sorbent has a surface area of 68 to 115 m²/g, preferably 70 to 110 m²/g, preferably 72.5 to 100 m²/g, preferably 77.5 to 95 m²/g, preferably 80 to 90 m²/g, preferably 82.5 to 85 m²/g, preferably 83.6 m²/g. In some embodiments, the nanocomposite sorbent has a pore volume of 0.15 to 0.40 cm³/g, preferably 0.16 to 0.38 cm³/g, preferably 0.17 to 0.36 cm³/g, preferably 0.18 to 0.34 cm³/g, preferably 0.19 to 0.32 cm³/g, preferably 0.2 to 0.3 cm³/g, preferably 0.22 to 0.29 cm³/g, preferably 0.24 to 0.28 cm³/g, preferably 0.26 to 0.275 cm³/g, preferably 0.272 cm³/g. In some embodiments, the nanocomposite sorbent has a pore size of 7.0 to 17.0 nm, preferably 8.0 to 16.0 nm, preferably 9.0 to 15.0 nm, preferably 10.0 to 14.0 nm, preferably 11.0 to 13.0 nm, preferably 11.5 to 12.75 nm, preferably 12.0 to 12.5 nm, preferably 12.25 to 12.40 nm, preferably 12.31 nm.

In some embodiments, the nanocomposite sorbent has a composition that includes 12.5 to 15 atom % carbon, preferably 13 to 14.5 atom % carbon, preferably 13.25 to 14.25 atom % carbon, preferably 13.5 to 14.0 atom % carbon, preferably 13.75 to 13.95 atom % carbon, preferably 13.85 to 13.90 atom % carbon, preferably 13.89 atom % carbon. In some embodiments, the nanocomposite sorbent has a composition that includes 12.5 to 15.0 atom % the first metal, preferably 13 to 14 atom % the first metal, preferably 13.1 to 13.75 atom % the first metal, preferably 13.25 to 13.5 atom % the first metal, preferably 13.35 to 13.45 atom % the first metal, preferably 13.4 atom % the first metal. In some embodiments, the nanocomposite sorbent has a composition that includes 5.0 to 10.0 atom % the second metal, preferably 6.0 to 9.0 atom % the second metal, preferably 7.0 to 8.5 atom % the second metal, preferably 7.25 to 8.25 atom % the second metal, preferably 7.5 to 8.0 atom % the second metal, preferably 7.75 to 7.90 atom % the second metal, preferably 7.86 atom % the second metal. In some embodiments, the nanocomposite sorbent has a composition that includes 0.25 to 2.5 atom % the third metal, preferably 0.5 to 2.0 atom % the third metal, preferably 0.75 to 1.75 atom % the third metal, preferably 1.0 to 1.5 atom % the third metal, preferably 1.25 to 1.40 atom % the third metal, preferably 1.29 atom % the third metal. In some embodiments, the nanocomposite sorbent has a composition that includes 4.0 to 9.0 atom % silicon, preferably 5.0 to 8.0 atom % silicon, preferably 5.5 to 7.5 atom % silicon, preferably 6.0 to 7.0 atom % silicon, preferably 6.25 to 6.75 atom % silicon, preferably 6.50 to 6.60 atom % silicon, preferably 6.53 atom % silicon.

In some embodiments, the nanocomposite sorbent has a composition that includes a ratio of the first metal to a total of the second metal and the third metal of 1.00:1 to 2.00:1, preferably 1.1:1 to 1.9:1, preferably 1:2:1 to 1.8:1, preferably 1.3:1 to 1.7:1, preferably 1.4:1 to 1.6:1, preferably 1.45:1 to 1.50:1, preferably 1.47:1 by atom %. In some embodiments, the nanocomposite sorbent has a composition that includes a ratio of carbon to nitrogen of 3.5 to 5.0 by atom %, preferably 3.75:1 to 4.75:1 by atom %, preferably 4.0:1 to 4.5:1 by atom %, preferably 4.1:1 to 4.4:1 by atom %, preferably 4.2:1 to 4.3:1 by atom %, preferably 4.28:1 by atom %.

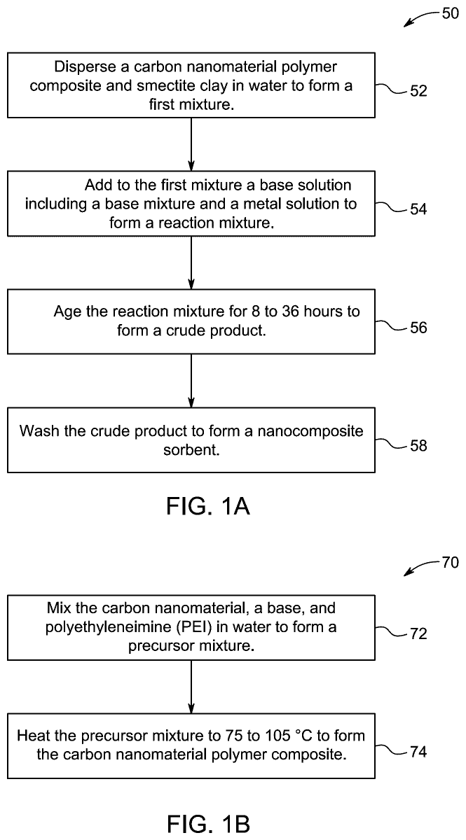

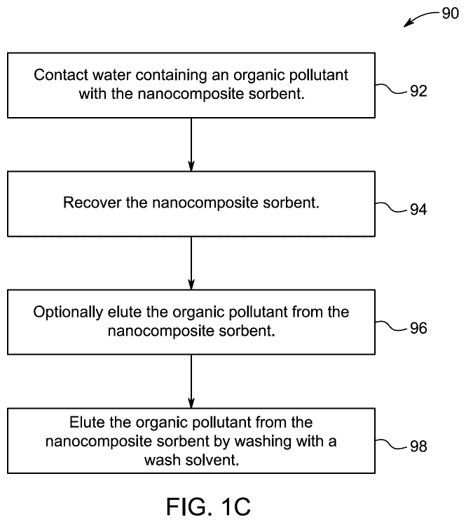

FIG. 1A illustrates a schematic flow chart of a method 50 of forming the nanocomposite sorbent according to an exemplary embodiment of the present application. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes dispersing the carbon nanomaterial polymer composite and smectite clay in water to form a first mixture.

At step 54, the method 50 includes adding to the first mixture a base solution including a base mixture and a metal solution to form a reaction mixture. The base mixture includes an alkali metal or alkaline earth metal carbonate and an alkali metal or alkaline earth metal hydroxide. The base solution and the metal solution are each an aqueous solution.

The metal solution includes a first metal, the second metal, and the third metal. In some embodiments, the first metal, the second metal, and the third metal are each present as a salt independently selected from a nitrate salt, a sulfate salt, a halide salt, an acetate salt, and a formate salt. For example. The first metal can be present or formulated as a nitrate salt and the second metal can be present or formulated as an acetate salt. In some embodiments, the first metal is magnesium. In some embodiments, the second metal is iron. In some embodiments, the third metal is aluminum. In some embodiments, the first metal is present as a salt selected from magnesium nitrate (Mg(NO₃)₂), magnesium sulfate (MgSO4), magnesium chloride (MgCl₂), magnesium acetate (Mg(CH₃COO)₂), magnesium formate (Mg(HCOO)₂). In some embodiments, the first metal is present at magnesium nitrate. In some embodiments, the second metal is present as a salt selected from ferric nitrate (Fe(NO₃)₃), ferrous sulfate (FeSO₄), ferric chloride (FeCl₃), ferrous acetate (Fe(CH₃COO)₂), ferrous formate (Fe(HCOO)₂). In some embodiments, the second metal is present at iron (III) nitrate. In some embodiments, the third metal is each present as a salt selected from aluminum nitrate (Al(NO₃)₃), aluminum sulfate (Al₂(SO₄)₃), aluminum chloride (AlCl₃), aluminum acetate (Al(CH₃COO)₃), aluminum formate (Al(HCOO)₃). In some embodiments, the third metal is present as aluminum nitrate. In a preferred embodiment, the metal solution includes magnesium nitrate, iron (III) nitrate, and aluminum nitrate.

At step 56, method 50 includes aging the reaction mixture for 8 to 36 hours, preferably 10 to 32 hours, preferably 12 to 28 hours, preferably 14 to 24 hours, preferably 15 to 20 hours, preferably 16 to 19 hours, preferably 17 hours to form a crude product. Aging the reaction mixture can be done by room-temperature aging, heating and cooling cycling, vacuum aging, solvent evaporation aging, aging in a controlled atmosphere, or aging under inert gas.

At step 58, the method 50 includes washing the crude product to form the nanocomposite sorbent. In general, the crude product can be washed with a suitable solvent, such as water and an organic solvent such as alcohols such as methanol, ethanol, n-propanol, 2-propanol (also known as isopropanol), ethylene glycol, diethylene glycol, and glycerol; hydrocarbons such as pentane, hexane, and heptane; ketones such as acetone and methyl ethyl ketone; esters such as ethyl acetate; amides such as dimethylformamide; ethers such as tetrahydrofuran, diglyme, and diethyl ether; nitriles such as acetonitrile; halogenated organic solvents such as methylene chloride (also known as dichloromethane), carbon tetrachloride, and chloroform; aromatic organic solvents such as benzene and xylene; amines such as trimethylamine and pyridine; and mixtures thereof. In some embodiments, the crude product is washed with water. In general, the washing can be performed any number of times. In some embodiments, the crude product is washed several (i.e., 2 to 20) times until all the impurities are removed to obtain the nanocomposite sorbent.

FIG. 1B illustrates a schematic flow chart of a method 70 forming the carbon nanomaterial polymer composite according to an exemplary embodiment of the present application. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes mixing the carbon nanomaterial, a base, and the polyethyleneimine (PEI) in water to form a precursor mixture. In some embodiments, the carbon nanomaterial is graphene oxide as described above. In some embodiments, the base may be selected from the group consisting of an alkaline earth metal hydroxide such as beryllium hydroxide (Be(OH)₂), magnesium hydroxide (Mg(OH)₂), strontium hydroxide (Sr(OH)₂), and calcium hydroxide (Ca(OH)₂) and an alkali metal hydroxide such as lithium hydroxide (LiOH), sodium hydroxide (NaOH), potassium hydroxide (KOH) and rubidium hydroxide (RbOH), and cesium hydroxide (CsOH). In some embodiments, the base is at least one of potassium carbonate, and sodium carbonate. In some embodiments, the base is KOH. In some embodiments, the weight ratio of the carbon nanomaterial to the base is in the range of 1:1 to 1:5, preferably 1:1 to 1:4, preferably 1:1 to 1:3, preferably 1:1 to 1:2, preferably 1:1.

At step 74, the method 70 includes heating the precursor mixture to 75 to 105° C., preferably 80 to 100° C., preferably 85 to 95° C., and preferably 90° C. for 12 to 48 hours, preferably 14 to 44 hours, preferably 16 to 40 hours, preferably 18 to 36 hours, preferably 20 to 32 hours, preferably 22 to 28 hours, preferably 24 hours to form the carbon nanomaterial polymer composite. In some embodiments, the heating can be performed by using heating appliances such as ovens, microwaves, autoclaves, hot plates, heating mantles and tapes, oil baths, salt baths, sand baths, air baths, hot-tube furnaces, and hot-air guns.

FIG. 1C illustrates a schematic flow chart of a method 90 of removing an organic pollutant from water according to an exemplary embodiment of the present application. In some embodiments, the organic pollutant is at least one selected from the group consisting of a dye, a phenol, a polycyclic aromatic hydrocarbon, an herbicide, a pesticide, and a persistent organic pollutant. In some embodiments, the organic pollutant may be a dye, a phenol, a polycyclic aromatic hydrocarbon, an herbicide, a pesticide, a persistent organic pollutant, or the like.

In some embodiments, the organic pollutant is a dye. A dye is a colored substance that chemically binds to a material it may be intended to color. Generally, a dye is applied to the solution, typically an aqueous solution. Examples of dyes include, but are not limited to: acridine dyes, which are acridine and its derivatives such as acridine orange, acridine yellow, acriflavine, and gelgreen; anthraquinone dyes, which are anthroaquinone and its derivatives such as acid blue 25, alizarin, anthrapurpurin, carminic acid, 1,4-diamno-2,3-dihydroanthraquinone, 7,14-dibenzypyrenequinone, dibromoanthrone, 1,3-dihydroxyanthraquinone, 1,4-dihydroxyanthraquinone, disperse red 9, disperse red 11, indanthrone blue, morindone, oil blue 35, parietin, quinizarine green SS, remazol brilliant blue R, solvent violet 13, 1,2,4-trihydroxyanthraquinone, vat orange 1, and vat yellow 1; diaryl methane dyes such as auramine O, triarylmethane dyes such as acid fuchsin, aluminon, aniline blue WS, aurin, aurintricarboxylic acid, brilliant blue FCF, brilliant green, bromocresol green, bromocresol purple, bromocresol blue, bromophenol blue, bromopyrogallol red, chlorophenol red, coomassie brilliant blue, cresol red, O-cresolphthalein, crystal violet, dichlorofluorescein, ethyl green, fast green FCT, FIAsH-EDT2, fluoran, fuchsine, green S, light green SF, malachite green, merbromin, metacresol purple, methyl blue, methyl violet, naphtholphthalein, new fuchsine, pararosaniline, patent blue V, phenol red, phenolphthalein, phthalein dye, pittacal, spirit blue, thymol blue, thymolphthalein, Victoria blue BO, Victoria blue R, water blue, xylene cyanol, and xylenol orange; azo dyes such as acid orange 5, acid red 13, alican yellow, alizarine yellow R, allura red AC, amaranth, amido black 10B, aniline yellow, arylide yellow, azo violet, azorubine, basic red 18, biebrich scarlet, Bismarck brown Y, black 7984, brilliant black BN, brown FK, chrysoine resorcinol, citrus red 2, congo red, D&C red 33, direct blue 1, disperse orange 1, eriochrome black T, evans blue, fast yellow AB, orange 1, hydroxynaphthol blue, janus green B, lithol rubine BK, metanil yellow, methyl orange, methyl red, methyl yellow, mordant brown 33, mordant red 19, naphthol AS, oil red 0, oil yellow DE, orange B, orange G, orange GGN, para red, pigment yellow 10, ponceau 2R, prontosil, red 2G, scarlet GN, Sirius red, solvent red 26, solvent yellow 124, sudan black B, sudan I, sudan red 7B, sudan stain, tartrazine, tropaeolin, trypan blue, and yellow 2G; phthalocyanine dyes such as phthalocyanine blue BN, phthalocyanine Green G, Alcian blue, and naphthalocyanine, azin dyes such as basic black 2, mauveine, neutral red, Perkin's mauve, phenazine, and safranin; indophenol dyes such as indophenol and dichlorophenolindophenol; oxazin dyes; oxazone dyes; thiazine dyes such as azure A, methylene blue, methylene green, new methylene blue, and toluidine blue; thiazole dyes such as primuline, stains-all, and thioflavin; xanthene dyes such as 6-carboxyfluorescein, eosin B, eosin Y, erythosine, fluorescein, rhodamine B, rose bengal, and Texas red; fluorone dyes such as calcein, carboxyfluorescein diacetate succinimidyl ester, fluo-3, fluo-4, indian yellow, merbromin, pacific blue, phloxine, and seminaphtharhodafluor; or rhodamine dyes such as rhodamine, rhodamine 6G, rhodamine 123, rhodamine B, sulforhodamine 101, and sulforhodamine B.

A phenol is an organic compound consisting of a hydroxyl group (—OH) bonded directly to an aromatic hydrocarbon group. Examples of phenols include, but are not limited to, phenol (the namesake of the group of compounds), bisphenols (including bisphenol A), butylated hydroxytoluene (BHT), 4-nonylphenol, orthophenyl phenol, picric acid, phenolphthalein and its derivatives mentioned above, xylenol, diethylstilbestrol, L-DOPA, propofol, butylated hydroxyanisole, 4-tert-butylcatechol, tert-butylhydroquinone, carvacrol, chloroxyleol, cresol (including M-, O-, and P-cresol), 2,6-di-tert-butylphenol, 2,4-dimethyl-6-tert-butylphenol, 2-ethyl-4,5-dimethylphenol, 4-ethylguaiacol, 3-ethylphenol, 4-ethylphenol, flexirubin, mesitol, 1-nonyl-4-phenol, thymol, 2,4,6-tri-tert-butylphenol, chlorophenol (including 2-, 3-, and 4-chlorophenol), dichlorophenol (including 2,4- and 2,6-dichlorophenol), bromophenol, dibromophenol (including 2,4-dibromophenol), nitrophenol, norstictic acid, oxybenzone, and paracetamol (also known as acetoaminophen).

A polycyclic aromatic hydrocarbon (PAH) is an aromatic hydrocarbon composed of multiple aromatic rings. Examples of polycyclic aromatic hydrocarbons include naphthalene, anthracene, phenanthrene, phenalene, tetracene, chrysene, triphenylene, pyrene, pentacene, benzo[a]pyrene, corannulene, benzo[g,h,i]perylene, coronene, ovalene, benzo[c]fluorine, acenaphthene, acenaphthylene, benz[a]anthracene, benzo[b]fluoranthene, benzo[j]fluoranthene, benzo[k]fluoranthene, benzo[e]pyrene, cyclopenta[c,d]pyrene, dibenz[a,h]anthracene, dibenzo[a,e]pyrene, dibenzo[a,h]pyrene, dibenzo[a,i]pyrene, dibenzo[a,l]pyrene, fluoranthene, fluorine, indeno[1,2,3-c,d]pyrene, 5-methylchrysene, naphthacene, pentaphene, picene, and biphenylene.

An herbicide (also known as “weedkiller”) is a substance that is toxic to plants and may kill, inhibit the growth of, or prevent the germination of plants. Herbicides are typically used to control the growth of or remove unwanted plants from an area of land, particularly in an agricultural context. Examples of herbicides include, but are not limited to, 2,4-D, aminopyralid, chlorsulfuron, clopyralid, dicamba, diuron, glyphosate, hexazinone, imazapic, imazapyr, methsulfuron methyl, picloram, sulfometuron methyl, triclopyr, fenoxaprop, fluazifop, quizalofop, clethodim, sethoxydim, chlorimuron, foramsulfuron, halosulfuron, nicosulfuron, primisulfuron, prosulfuron, rimsulfuron, thofensulfuron, tribenuron, imazamox, imazaquin, flumetsulam, cloransulam, thiencarbazone, fluoxpyr, diflufenzopyr, atrazine, simazine, metribuzin, bromoxynil, bentazon, linuron, glufosinate, clomazone, isoxaflutole, topramezone, mesotrione, tembotrione, acifluorfen, formesafen, lactofen, flumiclorac, flumioxazin, fulfentrazone, carfentrazone, fluthiacet-ethyl, falufenacil, paraquat, ethalfluralin, pendimethalin, trifluralin, butylate, EPTC, ecetochlor,alachlor, metolachlor, dimethenamid, flufenacet, and pyroxasulfone.

A pesticide is a substance meant to prevent, destroy, or control pests including, but not limited to algae, bacteria, fungi, plants, insects, mites, snails, rodents, and viruses. A pesticide intended for use against algae is known as an algicide. Examples of algicides include benzalkonium chloride, bethoxazin, cybutryne, dichlone, dichlorophen, diuron, endothal, fentin, isoproturon, methabenthiazuron, nabam, oxyfluorfen, pentachlorophenyl laurate, quinoclamine, quinonamid, simazine, terbutryn, and tiodonium.

A pesticide intended for use against bacteria is known as a bactericide. Examples of bactericides include antibiotics such as: aminoglycosides such as amikacin, gentamicin, kanamycin, neomycin, netilmicin, tobramycin, paromomycin, streptomycin, and spectinomycin; ansamycins such as geldanamycin, herbimycin, and rifaximin; carbacephems such as loracarbef; carbapenems such as ertapenem, doripenem, imipenem, and meropenem; cephalosporins such as cefadroxil, cefazolin, cephradine, cephapirin, cephalothin, cephalexin, cefaclor, cefoxitin, cefotetan, cefamandole, cefmetazole, cefonicid, cefprozil, cefuroxime, cefixime, cefdinir, cefditoren, cefoperazone, cefotaxime, cefpodoxime, cefazidime, ceftibuten, ceftizoxime, moxalactam, ceftriaxone, cefepime, cefaroline fosamil, and ceftobiprole; glycopeptides such as teicoplanin, vancomycin, telavancin, dalbavancin, and oritavancin; lincosamides such as clindamycin and lincomycin; lipopeptides such as daptomycin; macrolides such as azithromycin, clarithromycin, erythromycin, roxithromycin, telithromycin, spiramycin, and fidoxamicin; monobactams such as aztreonam; nitrofurans such as furazolidone and nitrofurantoin; oxazolidinones such as linezolid, posizolid, radezolid, and torezolid; penicillins such as amoxicillin, ampicillin, azlocillin, dicloxacillin, flucloxacillin, mezlocillin, methicillin, nafcillin, oxacillin, penicillins (including penicillin G and V), piperacillin, temocillin, and ticarcillin; polypeptides such as bacitracin, colistin, and polymyxin B; quinolones such as ciproflaxacin, enoxacin, gatifloxacin, gemifloxacin, levofloxacin, lomefloxacin, moxifloxacin, nadifloxacin, nalidixic acid, norfloxacin, ofloxacin, trovafloxacin, gepafloxacin, sparfloxacin, and temafloxacin; sulfonamides such as mafenide, sulfacetamide, sulfadiazine, sulfadithoxine, sulfamethizole, sulfamethoxazole, sulfanilamide, sulfasalazine, sulfisoxazole, and sulfonamidochrysoidine; tetracyclines such as demeclocycline, doxycycline, metacycline, minocycline, oxytetracycline, and tetracycline.

A pesticide intended for use against fungi is known as a fungicide. Examples of fungicides include acibenzolar, acypetacs, aldimorph, anilazine, aureofungin, azaconazole, azithiram, azoxystrobin, benalaxyl, benodanil, benomyl, benquinox, benthiavalicarb, binapacryl, biphenyl, bitertanol, bixafen, blasticidin-S, boscalid, bromuconazole, captafol, captan, carbendazim, carboxin, carpropamid, chloroneb, chlorothalonil, chlozolinate, cyazofamid, cymoxanil, cyprodinil, dichlofluanid, diclocymet, dicloran, diethofencarb, difenoconazole, diflumetorim, dimethachlone, dimethomorph, diniconazole, dinocap, dodemorph, edifenphos, enoxastrobin, epoxiconazole, etaconazole, ethaboxam, ethirimol, etridiazole, famoxadone, fenamidone, fenarimol, fenbuconazole, fenfuram, fenhexamid, fenoxanil, fenpropidin, fenpropimorph, ferbam, fluazinam, fludioxonil, flumorph, fluopicolide, fluopyram, fluoroimide, fluoxastrobin, flusilazole, flutianil, flutolain, flopet, fthalide, furalaxyl, guazatine, hexaconazole, hymexazole, imazalil, imibenconazole, iminoctadine, iodocarb, ipconazole, iprobenfos, iprodione, iprovalicarb, siofetamid, isoprothiolane, isotianil, kasugamycin, laminarin, mancozeb, mandestrobin, mandipropamid, maneb, mepanypyrim, mepronil, meptyldinocap, mealaxyl, metominostrobin, metconazole, methafulfocarb, metiram, metrafenone, myclobutanil, naftifine, nuarimol, octhilinone, ofurace, orysastrobin, oxadixyl, oxathiapiprolin, oxolinic acid, oxpoconazole, oxycarboxin, oxytetracycline, pefurazate, penconazole, pencycuron, penflufen, penthiopyrad, phenamacril, picarbutrazox, picoxystrobin, piperalin, polyoxin, probenzole, prochloraz, procymidone, propamocarb, propiconazole, propineb, proquinazid, prothiocarb, prothioconazole, pydiflumetofen, pyraclostrobin, pyrametostrobin, pyraoxystrobin, pyrazophos, pyribencarb, pyributicarb, pyrifenox, pyrimethanil, pyrimorph, pyriofenone, pyroquilon, quinoxyfen, quintozene, sedaxane, silthiofam, simeconazole, spiroxamine, streptomycin, tebuconazole, tebufloquin, teclofthalam, teenazene, terbinafine, tetraconazole, thiabendazole, thifluzamide, thiphanate, thiram, tiadinil, tolclosfos-methyl, folfenpyrid, tolprocarb, tolylfluanid, triadimefon, triadimenol, triazoxide, triclopyricarb, tricyclazole, tridemorph, trifloxystrobin, triflumizole, triforine, validamycin, and vinclozolin.

A pesticide intended for use against plants is known as an herbicide as described above. A pesticide intended for use against insects is known as an insecticide. Examples of insecticides are: organochlorides such as Aldrin, chlordane, chlordecone, DDT, dieldrin, endofulfan, endrin, heptachlor, hexachlorobenzene, lindane, methoxychlor, mirex, pentachlorophenol, and TDE; organophosphates such as acephate, azinphos-methyl, bensulide, chlorethoxyfos, chlorpyrifos, diazinon, chlorvos, dicrotophos, dimethoate, disulfoton, ethoprop, fenamiphos, fenitrothion, fenthion, malathion, methamdophos, methidathion, mevinphos, monocrotophos, naled, omethoate, oxydemeton-methyl, parathion, phorate, phosalone, phosmet, phostebupirim, phoxim, pirimiphos-methyl, profenofos, terbufos, and trichlorfon; carbamates such as aldicarb, bendiocarb, carbofuran, carbaryl, dioxacarb, fenobucarb, fenoxycarb, isoprocarb, methomyl; pyrethroids such as allethrin, bifenthrin, cyhalothrin, cypermethrin, cyfluthrin, deltamethrin, etofenprox, fenvalerate, permethrin, phenothrin, prallethrin, resmethrin, tetramethrin, tralomethrin, and transfluthrin; neonicotinoids such as acetamiprid, clothiandin, imidacloprid, nithiazine, thiacloprid, and thiamethoxam; ryanoids such as chlorantraniliprole, cyanthaniliprole, and flubendiamide.

A pesticide intended for use against mites is known as a miticide. Examples of miticides are permethrin, ivermectin, carbamate insecticides as described above, organophosphate insecticides as described above, dicofol, abamectin, chlorfenapyr, cypermethrin, etoxazole, hexythiazox, imidacloprid, propargite, and spirotetramat.

A pesticide intended for use against snails and other mollusks is known as a molluscicide. Examples of molluscicides are metaldehyde and methiocarb.

A pesticide intended for use against rodents is known as a rodenticide. Examples of rodenticides are warfarin, coumatetralyl, difenacoum, brodifacoum, flocoumafen, bromadiolone, diphacinone, chlorophacinone, pindone, difethialone, cholecalciferol, ergocalciferol, ANTU, chloralose, crimidine, 1,3-difluoro-2-propanol, endrin, fluroacetamide, phosacetim, pyrinuron, scilliroside, strychnine, tetramethylenedisulfotetramine, bromethalin, 2,4-dinitrophenol, and uragan D2.

A pesticide intended for use against viruses is known as a virucide. Examples of virucides are cyanovirin-N, griffithsin, interferon, NVC-422, scytovirin, urumin, virkon, zonroz, and V-bind viricie.

A persistent organic pollutant is a toxic organic chemical that adversely affects human and environmental health, can be transported by wind and water, and can persist for years, decades, or centuries owing to resistance to environmental degradation by natural chemical, biological, or photolytic processes. Persistent organic pollutants are regulated by the United Nations Environment Programme 2001 Stockholm Convention on Persistent Organic Pollutants. Examples of persistent organic pollutants are Aldrin, chlordane, dieldrin, endrin, heptachlor, hexachlorobenzene, mirex, toxaphene, polychlorinated biphenyl (PCBs), dichlorodiphenyltrichloroethane (DDT), dioxins, polychlorinated dibenzofurans, chlordecone, hexachlorocyclohexane (α- and β-), hexabromodiphenyl ether, lindane, pentachlorobenzene, tetrabromodiphenyl ether, perfluorooctanesulfonic acid, endosulfans, and hexabromocyclododecane.

At step 92, the method 90 includes contacting water containing an organic pollutant with the nanocomposite sorbent. In a preferred embodiment, the organic pollutant includes methyl orange (MO) and/or crystal violet (CV).

At step 94, the method 90 includes recovering the nanocomposite sorbent. In general, the nanocomposite sorbent can be recovered by any technique for separating a liquid and a solid. Examples of suitable techniques include decantation, centrifugation, filtration, evaporation, and distillation. In some embodiments, the nanocomposite sorbent can be recovered using centrifugation. As used herein, the term ‘centrifugation’ refers to the process in which a mixture is subjected to rapid spinning around a central axis, generating centrifugal force that causes denser components to move outward and sediment at the bottom of a container or to be separated from less dense components. This technique separates solids from liquids, isolates particles of different sizes or densities, and clarifies suspensions or extracts. In some embodiments, any other desorption techniques conventionally used in the art may be used as well.

At step 96, the method 90 includes optionally eluting the organic pollutant from the nanocomposite sorbent. In some embodiments, the organic pollutant from the nanocomposite sorbent can be eluted by a base. In general, the base can be any suitable base as described above. In some embodiments, the base used for the eluting is NaOH. In some embodiments, following the eluting, the nanocomposite sorbent can be rinsed several times with distilled water.

At step 98, the method 90 includes eluting the organic pollutant from the nanocomposite sorbent by washing with a wash solvent. In some embodiments, the method removes 750 to 1100 mg methyl orange per gram of nanocomposite sorbent at a pH of 2 to 4. 425 to 650 mg crystal violet per gram, more preferably 439.2 mg/g of nanocomposite sorbent at a pH of 6 to 8, more preferably 8.

### EXAMPLES

The following examples demonstrate certain embodiments of a nanocomposite sorbent as described herein. The examples are provided solely for illustration and are not to be construed as limitations of the present disclosure, as many variations are possible without departing from the spirit and scope of the present disclosure.

### Example 1: Synthesis of AGO Adsorbent

The synthesis of graphene oxide (GO) followed the widely adopted improved Hummer's method [D. C. Marcano, D. V. Kosynkin, J. M. Berlin, A. Sinitskii, Z. Sun, A. Slesarev, L. B. Alemany, W. Lu, J. M. Tour, Improved synthesis of graphene oxide, ACS Nano. 4 (2010), incorporated herein by reference]. To functionalize GO with polyethyleneimine (PEI), 1 g of GO was dispersed in 1000 mL of distilled water and then sonicated for 1 h. After this, 100 mg of PEI in an aqueous solution was added to the GO dispersion. This combination was stirred intensively at ambient temperature for 2 h to ensure uniform mixing. 2 g of KOH was then introduced into this mixture and stirred for an additional 10 min. This blend was then continuously stirred and refluxed at 90° C. for a full day. The color change of the mixture from yellow-brown to black inidcated the successful integration of PEI with GO. To purify and recover the resultant AGO, the mixture was centrifuged at 8000 rpm for 15 min and rinsed with distilled water multiple times. Finally, the retrieved AGO was dried in an oven set at 50° C. and then pulverized into a fine consistency.

### Example 2: Graphene Oxide-Bentonite-Layered Triple Hydroxide (AGO/Bentonite/MgFeAl-LTH) Nanocomposite Synthesis

The AGO/Bentonite/MgFeAl-LTH nanocomposite was synthesized using the co-precipitation technique. Two distinct solutions were prepared: solution A, comprising 27.9 mM Na₂CO₃ and 334.8 mM NaOH, and solution B, which included 111.6 mM Mg(NO₃)_{2·}6H₂O, 11.16 mM Fe(NO3)₃·9H2O, and 44.64 mM Al(NO₃)₃·9H₂O. Concurrently, the AGO/Bentonite composite was synthesized by blending 1.05 g of bentonite in 200 mL distilled water, ensuring its even dispersion by stirring at room temperature for 30 min. The pH of this dispersion was adjusted to a range of 10-11 using solution A and then subjected to 1 h of sonication at 50% amplitude. An equivalent quantity of AGO (1.05 g) was introduced to the bentonite mixture, and the combined mixture was sonicated for another 1 h at the same amplitude. Thereafter, solutions A and B were added dropwise to the AGO/Bentonite mixture, preserving the (Mg²⁺/(bentonite+AGO)) ratio at 3. During this procedure, continuous stirring was maintained, ensuring the pH of the reaction mixture remained between 10-12 by controlling the addition rate of solutions A and B. After the combined solutions were stirred for an extra 17 h at room temperature, it was centrifuged at 8000 rpm to remove surplus salts. This was followed by repeated washing using distilled water at least seven times. Finally, the resultant AGO/Bentonite/MgFeAl-LTH nanocomposite was oven-dried at 80° C. and pulverized to a fine consistency.

### Example 3: Characterizations

The synthesized adsorbent's structural and surface features were assessed using scanning electron microscopy integrated with energy dispersive spectrometry (SEM/EDS). This technique offers detailed insight into the adsorbent's surface texture and composition. X-ray diffraction (XRD) was used to analyze crystallinity, focusing on an angular spectrum (20) from 5° to 70°. The surface functional groups of the adsorbents were identified through Fourier Transform Infrared (FTIR) spectroscopy, recording spectra between 4000 and 500 cm¹. These methods allowed for elucidation of the adsorbent's surface attributes, crystalline nature, and specific functional groups. To investiagate the adsorbents' porous features, such as pore volume, size, and specific surface area, the Brunauer-Emmett-Teller (BET) method was used [S. Brunauer, P. H. Emmett, E. Teller, Adsorption of Gases in Multimolecular Layers, J. Am. Chem. Soc. 60 (1938), incorporated herein by reference]. N₂ adsorption/desorption patterns were observed at 77 K using an advanced adsorption system during the BET analysis.

### Example 4: Zeta Potential Measurements

Zeta potential measurements were carried out to understand the adsorption mechanisms of methyl orange (MO) and crystal violet (CV) on the AGO/Bentonite/MgFeAl-LTH nanocomposite and compared with the other adsorbents, such as GO, AGO, Bentonite, MgFeAl-LTH, and their combinations. For these tests, solutions containing 1 mM NaCl served as the background electrolyte and were purged with N₂ for 3 min to eliminate dissolved gases like CO₂ and O₂. Subsequently, the pH levels of solutions were set to 2, 4, 5, 6, 8, 9, 10, and 12 using either 100 mM HCl or NaOH. Each adsorbent was introduced into the pH-adjusted solutions at a dose of 50 mg/L and then purged again with N₂. After that, the mixtures were shaken for 24 h at 250 rpm. Once the shaking period ended, each mixture underwent 7 min of sonication before the zeta potential assessments.

### Example 5: Adsorption Experiments

Adsorption tests were undertaken to consider the performance of AGO/Bentonite/MgFeAl-LTH nanocomposite under varying conditions. Initially, the efficacy of AGO/Bentonite/MgFeAl-LTH nanocomposite was compared to GO, AGO, bentonite, MgFeAl-LTH, and their various combinations, using MO and CV as model dye pollutants. Standard test conditions included an initial pollutant concentration of 100 mg/L for both MO and CV, an adsorbent dosage of 50 mg/L, a pH of 6, 20 h of contact time, a constant temperature of 25° C., and a shaking rate of 250 rpm. After each test, roughly 5 mL of the sample was filtered and analyzed spectroscopically to determine the remaining adsorbate concentration. Preliminary tests highlighted the enhanced performance of the AGO/Bentonite/MgFeAl-LTH nanocomposite, leading to its selection for more in-depth studies. After determining the most effective CV and MO adsorbent (i.e., AGO/Bentonite/MgFeAl-LTH), further studies (i.e., isotherm, kinetics, and regeneration) were conducted at pH of 6 and temperature of 25° C. To further investigate the influence of pH on MO and CV adsorption using the AGO/Bentonite/MgFeAl-LTH nanocomposite, optimum pH was determined by varying the pH of the CV and MO aqueous solutions in the range from (2 to 8) and (2 to 12), respectively.

The regenerability and reusability of the AGO/Bentonite/MgFeAl-LTH nanocomposite were assessed by conducting five cycles of the adsorption-desorption process. After each cycle, the adsorbent was recovered using centrifugation, washed three times with 0.2 M NaOH, followed by several rinses with distilled water, and dried at 80° C.

### Example 6: Characterization of the Synthesized Composites

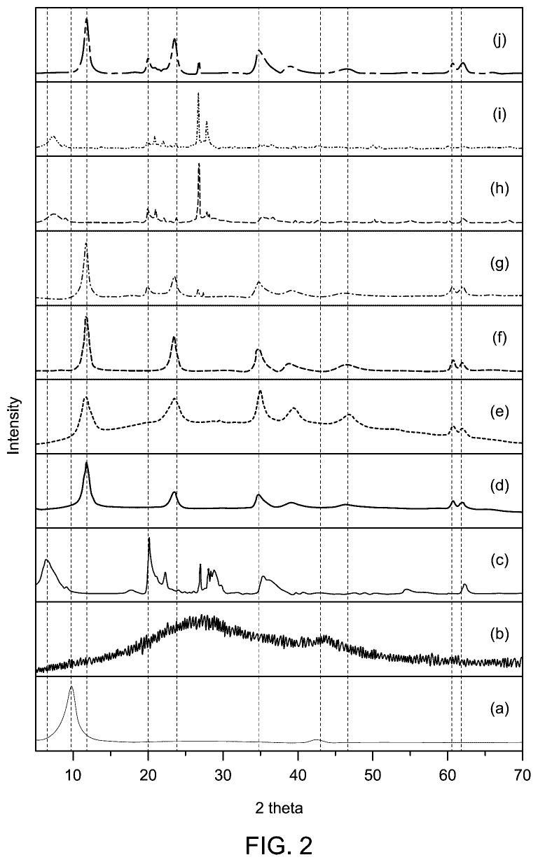

FIG. 2 shows the diffraction patterns of various materials and their composites, including GO, AGO, Bentonite, MgFeAl-LTH, and their combinations. In trace (a), the X-ray diffraction (XRD) analysis for GO adsorbent reveals a pronounced diffraction peak at 9.650 and a secondary peak at 42.60°. These peaks are assigned to the (002) and (101) planes. Using Bragg's Law, the interlayer distance of GO “D” was calculated to be around 0.901 nm, aligning well with other reports [T. Tsoufis, F. Katsaros, Z. Sideratou, B. J. Kooi, M. A. Karakassides, A. Siozios, Intercalation study of low-molecular-weight hyperbranched polyethyleneimine into graphite oxide, Chem.—A Eur. J. 20 (2014); and A. B. Bourlinos, D. Gournis, D. Petridis, T. Szabó, A. Szeri, I. Dékány, Graphite oxide: Chemical reduction to graphite and surface modification with primary aliphatic amines and amino acids, Langmuir. 19 (2003), each of which is incorporated herein by reference]. With PEI molecules covalently bonded to the GO sheets, the predominant GO peak vanishes, giving rise to a broad peak near 2θ=23.5°, as seen in trace (b). This shift indicates the PEI chains intercalate into the GO sheet edges [Y. He, Y. Xia, J. Zhao, Y. Song, L. Yi, L. Zhao, One-step fabrication of PEI-modified GO particles for CO 2 capture, Appl. Phys. A Mater. Sci. Process. 125 (2019), incorporated herein by reference]. Trace (c) shows the XRD pattern of Bentonite adsorbent where a peak at 2θ=6.52° is noticed, corresponding to the (001) plane. Another peak at 2θ=26.5° indicates Bentonite quartz phase composition. Moreover, the XRD pattern of MgFeAl-LTH, as illustrated in trace (d), presents six peaks ranging from 11.760 to 61.91°. These peaks are consistent with the hexagonal structure of MgFeAl-LTH, as specified 5 in (JCPDS 70-2151) [R. Benhiti, A. Ait Ichou, A. Zaghloul, G. Carja, M. Zerbet, F. Sinan, M. Chiban, Kinetic, isotherm, thermodynamic and mechanism investigations of dihydrogen phosphate removal by MgAl-LDH, Nanotechnol. Environ. Eng. 6 (2021), incorporated herein by reference]. Using the equations below (Eq. (1-2)), the lattice parameters “a” and “c” and the crystal size “D” were calculated to be 30 Å, 23 Å, and 9 nm, respectively [R. Benhiti, A. Ait Ichou, A. Zaghloul, G. Carja, M. Zerbet, F. Sinan, M. Chiban, Kinetic, isotherm, thermodynamic and mechanism investigations of dihydrogen phosphate removal by MgAl-LDH, Nanotechnol. Environ. Eng. 6 (2021), incorporated herein by reference].

$$D = 0.9 λ ( β cos θ ) \qquad ( 1 )$$

$$\frac{1}{{d}^{2}} = \frac{4}{3} \frac{( {h}^{2} + hk + {k}^{2} )}{{a}^{2}} + \frac{{l}^{2}}{{c}^{2}} \qquad ( 2 )$$

Where the Miller indices are represented by (l, h, and k), the full width at the midpoint of the diffraction peaks is denoted by β, and the diffraction angle is given by θ. Interestingly, except that the grain size of GO/MgFeAl-LTH shrinks to 5 nm, AGO/MgFeAl-LTH and GO/MgFeAl-LTH mainly retain MgFeAl-LTH structural properties, as depicted in traces (e) and (f). Upon intercalating Bentonite with MgFeAl-LTH, as seen in trace (g), the XRD pattern of Bentonite/MgFeAl-LTH retains MgFeAl-LTH reflections. Moreover, the XRD results are presented in trace (g) indicates that the peak at 20=26.5° of bentonite in the Bentonite/MgFeAl-LTH is mostly undetected; this could be attributed to the low amount of bentonite incorporated into the composite. Some characteristic reflections of Bentonite in the composite indicate the intercalation of Bentonite particles in the interlayers of MgFeAl-LTH. Similar findings were found in [N. D. Mu'azu, N. Jarrah, T. S. Kazeem, M. Zubair, M. Al-Harthi, Bentonite-layered double hydroxide composite for enhanced aqueous adsorption of Eriochrome Black T, Appl. Clay Sci. 161 (2018) 23-34, incorporated herein by reference].

In traces (h) and (i), the Bentonite peak at 20=6.520 (001) shifts to 20=7.47° post the creation of GO/Bentonite and/or AGO/Bentonite composites. This shift, combined with Bragg's law, signifies a decrease in the layer spacing of the composite, from 1.57 nm in the Bentonite adsorbent to 1.55 nm in the composites, indicating GO or AGO intercalation into Bentonite. Finally, the XRD pattern of AGO/Bentonite/MgFeAl-LTH nanocomposite in trace (j) mirrors that of MgFeAl-LTH, but with a decreased peak at 20=26.5°, attributing this to the domination presence of MgFeAl-LTH in the composite.

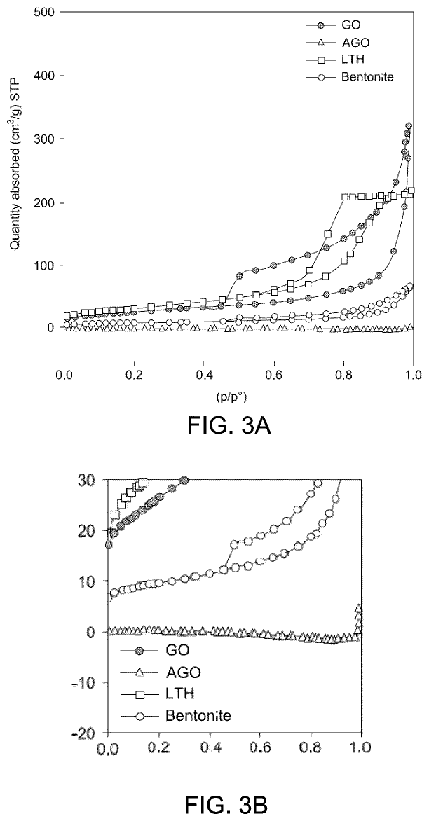

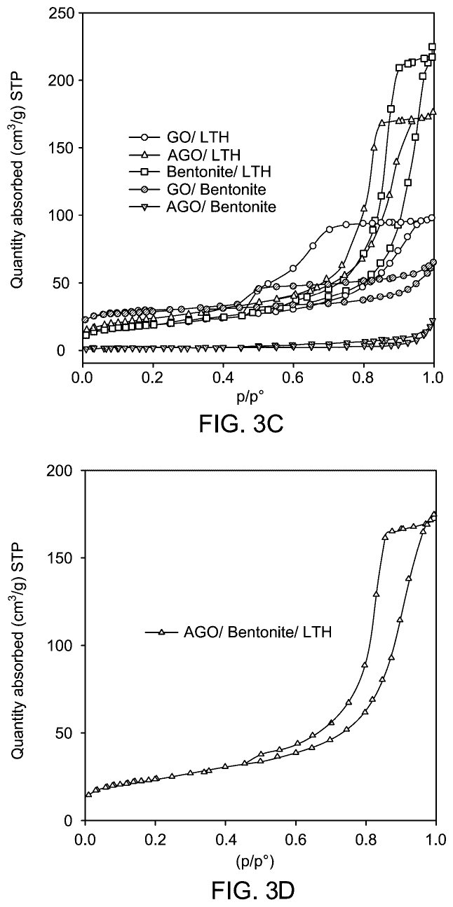

FIGS. 3A-3D illustrates the N₂ adsorption and desorption isotherms onto/from all synthesized materials conducted at 77 K. The patterns observed in FIGS. 3A-3D for all materials align with the IUPAC type IV curve, typically shown in mesoporosity adsorbents [A. A. Q. Al-qadri, Q. A. Drmosh, S. A. Onaizi, Case Studies in Chemical and Environmental Engineering Enhancement of bisphenol a removal from wastewater via the covalent functionalization of graphene oxide with short amine molecules, Case Stud. Chem. Environ. Eng. 6 (2022) 100233; A. M. Alkadhem, M. A. A. Elgzoly, A. Alshami, S. A. Onaizi, Kinetics of CO₂ capture by novel amine-functionalized magnesium oxide adsorbents, Colloids Surfaces A Physicochem. Eng. Asp. 616 (2021); and A. M. Alkadhem, M. A. A. Elgzoly, S. A. Onaizi, Novel Amine-Functionalized Magnesium Oxide Adsorbents for CO₂ Capture at Ambient Conditions, J. Environ. Chem. Eng. 8 (2020), each of which is incorporated herein by reference]. The only exception is the AGO adsorbent, which follows the IUPAC type II curve. Furthermore, the H₂(b) hysteresis pattern depicted in FIGS. 3A-FIG. 3D is observed in these materials (i.e., MgFeAl-LTH, GO/MgFeAl-LTH, AGO/MgFeAl-LTH, Bentonite/MgFeAl-LTH, and AGO/Bentonite/MgFeAl-LTH) which have a more restricted pore cavity in relation to their neck size distribution [K. A. Cychosz, M. Thommes, Progress in the Physisorption Characterization of Nanoporous Gas Storage Materials, Engineering. 4 (2018) 559-566, incorporated herein by reference]. All other materials, such as GO, AGO, Bentonite, GO/Bentonite, and AGO/Bentonite, align with the H4 hysteresis model.

Table 1 provides a detailed analysis of the N₂ adsorption and desorption isotherms, including surface area, pore size, and pore volume. The findings indicate that the values of the pore size for all adsorbents (except AGO) indicate that these materials fall within the class of mesoporous adsorbents (with pore diameters ranging from 2 nm to 50 nm) [A. M. Alkadhem, M. A. A. Elgzoly, A. Alshami, S. A. Onaizi, Kinetics of CO₂ capture by novel amine-functionalized magnesium oxide adsorbents, Colloids Surfaces A Physicochem. Eng. Asp. 616 (2021); and A. M. Alkadhem, M. A. A. Elgzoly, S. A. Onaizi, Novel Amine-Functionalized Magnesium Oxide Adsorbents for CO₂ Capture at Ambient Conditions, J. Environ. Chem. Eng. 8 (2020), each of which is incorporated herein by reference]. Additionally, Table 1 shows that the AGO/Bentonite/MgFeAl-LTH nanocomposite boasts a specific surface area of 83.6 m²/g, a pore volume of 0.272 cm³/g, and a pore size of 12.31 nm. This indicates that while the AGO/Bentonite/MgFeAl-LTH nanocomposite has a more expansive surface area than either AGO (1.1 m²/g) or Bentonite (34.0 m²/g), it doesn't surpass the MgFeAl-LTH adsorbent, which has a specific surface area of 114.8 m²/g.

TABLE 1
Textural properties of the synthesized composites
and their parental materials.

| | BET Properties | | |
|---|---|---|---|
| | S | Pore Volume | Pore |
| Material | (m²/g) | (cm³/g) | Size (nm) |
| GO | 91.5 | 0.50 | 20.90 |
| AGO | 1.1 | 0.01 | 177.62 |
| Bentonite | 34.0 | 0.11 | 16.79 |
| MgFeAl-LTH | 114.8 | 0.33 | 9.65 |
| GO/MgFeAl-LTH | 64.3 | 0.15 | 9.23 |
| AGO/MgFeAl-LTH | 83.6 | 0.27 | 11.21 |
| Bentonite/MgFeAl-LTH | 68.7 | 0.35 | 18.45 |
| GO/Bentonite | 100.7 | 0.08 | 8.98 |
| AGO/Bentonite | 5.6 | 0.03 | 45.95 |
| AGO/Bentonite/MgFeAl-LTH | 83.6 | 0.27 | 12.31 |

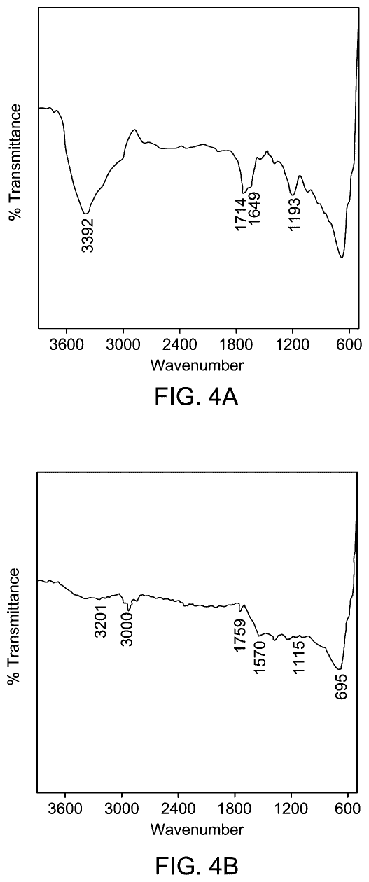

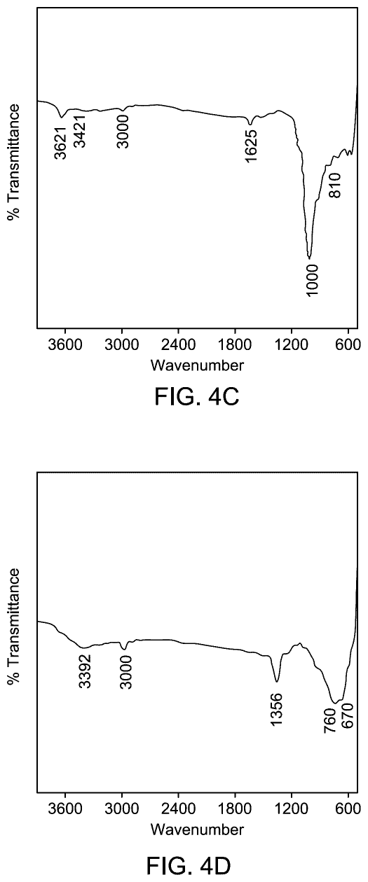

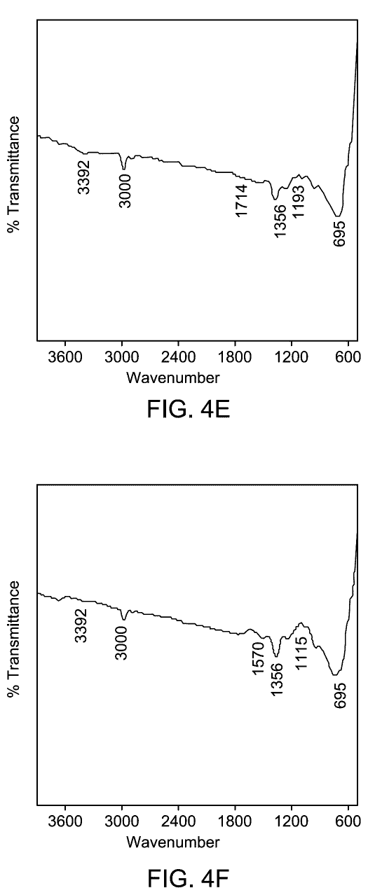

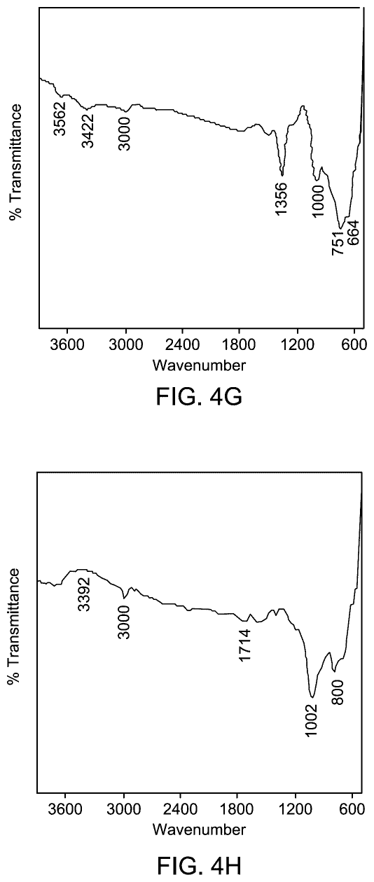

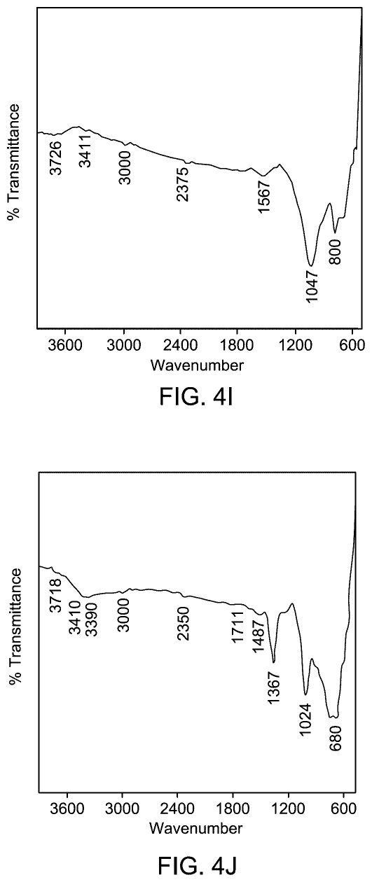

The Fourier Transform Infrared (FTIR) spectrum of GO, as shown in FIG. 4A, displays several peaks characteristic of specific functional groups. A major peak at 3392 cm⁻¹ indicates 0-H stretching, linked to hydroxyl groups and possibly intermolecularly hydrogen-bonded water. A peak near 1714 cm⁻¹ represents C═O stretching from carbonyl groups at the GO edges. The absorption at 1649 cm⁻¹ indicates C═C stretching from unoxidized graphitic domains. Peaks at 1143 cm⁻¹ and 1103 cm⁻¹ can be attributed to C—O stretching from epoxy or alkoxy groups and C—O—C stretching from ether linkages, respectively [Y. Gong, D. Li, Q. Fu, C. Pan, Influence of graphene microstructures on electrochemical performance for supercapacitors, Prog. Nat. Sci. Mater. Int. 25 (2015), incorporated herein by reference]. The FTIR spectrum for AGO, which represents GO functionalized with PEI, shows distinct features that indicate the introduction of nitrogen-containing functional groups, as shown in FIG. 4B. A peak at 3201 cm⁻¹ can be assigned to N—H stretching vibrations, which indicates the presence of primary and secondary amines from the PEI. Additionally, the peak around 1570 cm⁻¹ is consistent with the C—N stretching of amine groups, indicating the successful grafting of PEI onto the GO framework [A. A. Q. Al-qadri, Q. A. Drmosh, S. A. Onaizi, Case Studies in Chemical and Environmental Engineering Enhancement of bisphenol a removal from wastewater via the covalent functionalization of graphene oxide with short amine molecules, Case Stud. Chem. Environ. Eng. 6 (2022) 100233; and S. Verma, R. K. Dutta, A facile method of synthesizing ammonia modified graphene oxide for efficient removal of uranyl ions from aqueous medium, RSC Adv. 5 (2015), each of which is incorporated herein by reference]. Comparatively, while peaks related to oxygen functionalities like those at 1759 cm⁻¹ for C═O stretching and 1115 cm⁻¹ for C—O stretching can still be observed, their intensities or positions appear to have changed slightly due to interactions with PEI. This spectrum indicates the successful functionalization of GO with PEI, demonstrating both the retention of some oxygen-containing groups from GO and the addition of nitrogen-based functionalities from PEI.

The FTIR spectrum for bentonite, as shown in FIG. 4C, provides insights into the functional groups present in the clay. The peak observed around 3621 cm⁻¹ corresponds to the O—H stretching vibrations, attributed to the hydroxyl groups present in the aluminosilicate layers of the bentonite structure. The band near 1000 cm⁻¹ is characteristic of Si—O stretching vibrations from the silicate layers, a fundamental constituent of bentonite. The peak at 1625 cm⁻¹ could also be attributed to the bending mode of molecular water (H—O—H bending of H₂O) trapped or adsorbed between the aluminosilicate layers. Lastly, the feature around 810 cm⁻¹ can be attributed to Al—OH or Si—OH deformation vibrations [W. Xu, Y. Chen, W. Zhang, B. Li, Fabrication of graphene oxide/bentonite composites with excellent adsorption performances for toluidine blue removal from aqueous solution, Adv. Powder Technol. 30 (2019) 493-501, incorporated herein by reference]. The FTIR spectrum of MgFeAl-LTH in FIG. 4D shows some of the fundamental vibrational modes of its constituting functional groups. The pronounced peak near 3392 cm⁻¹ corresponds to 0-H stretching vibrations, which could arise from hydroxyl groups within the MgFeAl-LTH structure and physically adsorbed water molecules. The peak adjacent to it, at around 3000 cm⁻¹, could also be attributed to the O—H stretching but may be associated with bound water molecules or the intrinsic hydroxyl groups in MgFeAl-LTH. The band observed around 1356 cm⁻¹ is typically related to the carbonate anion (CO₃²⁻) and nitrate ions (NO₃⁻), which often exist as interlayer anions in many MgFeAl-LTH compounds. The band represents the C—O symmetric stretching in such species [See. S. Song, L. Yin, X. Wang, L. Liu, S. Huang, R. Zhang, T. Wen, S. Yu, D. Fu, T. Hayat, X. Wang, Interaction of U(VI) with ternary layered double hydroxides by combined batch experiments and spectroscopy study, Chem. Eng. J. 338 (2018); and X. Mei, J. Wang, R. Yang, Q. Yan, Q. Wang, Synthesis of Pt doped Mg—Al layered double oxide/graphene oxide hybrid as novel NOx storage-reduction catalyst, RSC Adv. 5 (2015), each of which is incorporated herein by reference].

Moreover, the FTIR spectra of GO/MgFeAl-LTH and AGO/MgFeAl-LTH composites, as shown in FIG. 4E and FIG. 4F resemble that of MgFeAl-LTH due to the high amount of Mga²⁺ (MgFeAl-LTH precursor) compared to the amount of GO and AGO, except that the transmittance intensities of peaks at 3392 and 1356 cm⁻¹ are reduced and the appearance of the peak at 1570 cm⁻¹ in AGO/MgFeAl-LTH which is ascribed to N—H group. The FTIR spectrum of the Bentonite/MgFeAl-LTH composite in FIG. 4G shows peaks observed at approximately 3562 cm⁻¹, which can be associated with the hydroxyl groups present in the clay mineral structure of bentonite or potentially from MgFeAl-LTH. Next, the broad band centered around 3422 cm⁻¹ further highlights the O—H stretching but might be more associated with adsorbed water molecules or hydrogen-bonded hydroxyl groups. The peak observed at around 1356 cm⁻¹ is possibly due to the presence of carbonate and nitrate groups from MgFeAl-LTH. The distinct peak near 1000 cm⁻¹ is characteristic of the Si—O stretching vibration found in bentonite. Lastly, the peaks present at approximately 754 cm⁻¹ and 664 cm⁻¹ correspond to bending modes of aromatic rings or potentially Al—OH or Mg—OH deformation in bentonite [N. D. Mu′azu, N. Jarrah, T. S. Kazeem, M. Zubair, M. Al-Harthi, Bentonite-layered double hydroxide composite for enhanced aqueous adsorption of Eriochrome Black T, Appl. Clay Sci. 161 (2018) 23-34, incorporated herein by reference in its entirety].

In the spectrum for GO/Bentonite (FIG. 4H), the pronounced peak at approximately 3392 cm⁻¹ signifies the presence of O—H stretching, likely from hydroxyl groups in GO and the inherent clay mineral structure of bentonite. The peak near 1714 cm⁻¹ can be attributed to the C═O stretching vibration, indicating the presence of carboxylic groups typical of GO. The peak around 1002 cm-1 is attributable to Si—O stretching vibration from bentonite [W. Xu, Y. Chen, W. Zhang, B. Li, Fabrication of graphene oxide/bentonite composites with excellent adsorption performances for toluidine blue removal from aqueous solution, Adv. Powder Technol. 30 (2019) 493-501, incorporated herein by reference in its entirety]. Meanwhile, the spectrum for AGO/Bentonite (FIG. 4I) also presents a strong O—H stretching band at around 3726 cm⁻¹, with a broader band centered at 3411 cm⁻¹, potentially denoting increased interaction or hydrogen bonding between components. The presence of the 3201 cm⁻¹ band might indicate N—H stretching in AGO. The peaks at 1567 cm⁻¹ and 1047 cm⁻¹ further support the existence of C—N and Si—O—Si linkages, respectively. Lastly, the FTIR spectrum of AGO/Bentonite/MgFeAl-LTH nanocomposite is shown in FIG. 4J. The peaks located at 3718 cm⁻¹ and the broad peak near 3410 cm⁻¹ can be assigned to the stretching oscillation of the hydroxyl group (0-H) in Al—OH and the silanol (Si—O—H) groups within the bentonite, respectively. Furthermore, the pronounced peak around 3410 cm⁻¹ may also correspond to the O—H group of water molecules in the AGO/Bentonite/MgFeAl-LTH nanocomposite [H. Zaitan, D. Bianchi, O. Achak, T. Chafik, A comparative study of the adsorption and desorption of o-xylene onto bentonite clay and alumina, J. Hazard. Mater. 153 (2008); and Y. S. Chang, P. I. Au, N. M. Mubarak, M. Khalid, P. Jagadish, R. Walvekar, E. C. Abdullah, Adsorption of Cu(II) and Ni(II) ions from wastewater onto bentonite and bentonite/GO composite, Environ. Sci. Pollut. Res. 27 (2020), each of which is incorporated herein by reference in its entirety]. The existence of water in the formulated AGO/Bentonite/MgFeAl-LTH nanocomposite might result from the retained moisture in the examined specimen or the hygroscopic nature of KBr [A. M. Alkadhem, M. A. A. Elgzoly, A. Alshami, S. A. Onaizi, Kinetics of CO₂ capture by novel amine-functionalized magnesium oxide adsorbents, Colloids Surfaces A Physicochem. Eng. Asp. 616 (2021); A. M. Alkadhem, M. A. A. Elgzoly, S. A. Onaizi, Novel Amine-Functionalized Magnesium Oxide Adsorbents for CO₂ Capture at Ambient Conditions, J. Environ. Chem. Eng. 8 (2020); and A. Al-Fakih, M. Q. Ahmed Al-Koshab, W. Al-Awsh, Q. A. Drmosh, M. A. Al-Osta, M. A. Al-Shugaa, S. A. Onaizi, Mechanical, hydration, and microstructural behavior of cement paste incorporating Zeolitic imidazolate Framework-67 (ZIF-67) nanoparticles, Constr. Build. Mater. 348 (2022)9,10,19, each of which is incorporated herein by reference in its entirety]. The broad absorption peak near 3200 cm⁻¹ could also be attributed to the N—H stretching vibration from the PEI molecules [A. A. Q. Al-qadri, Q. A. Drmosh, S. A. Onaizi, Case Studies in Chemical and Environmental Engineering Enhancement of bisphenol a removal from wastewater via the covalent functionalization of graphene oxide with short amine molecules, Case Stud. Chem. Environ. Eng. 6 (2022) 100233; and S. Verma, R. K. Dutta, A facile method of synthesizing ammonia modified graphene oxide for efficient removal of uranyl ions from the aqueous medium, RSC Adv. 5 (2015), each of which is incorporated herein by reference in its entirety]. The peak observed approximately at 3000 cm⁻¹ might arise from the stretching vibration of the O—H present in the carboxylic acid in GO. Other peaks observed are most likely similar to the peaks observed in MgFeAl-LTH.

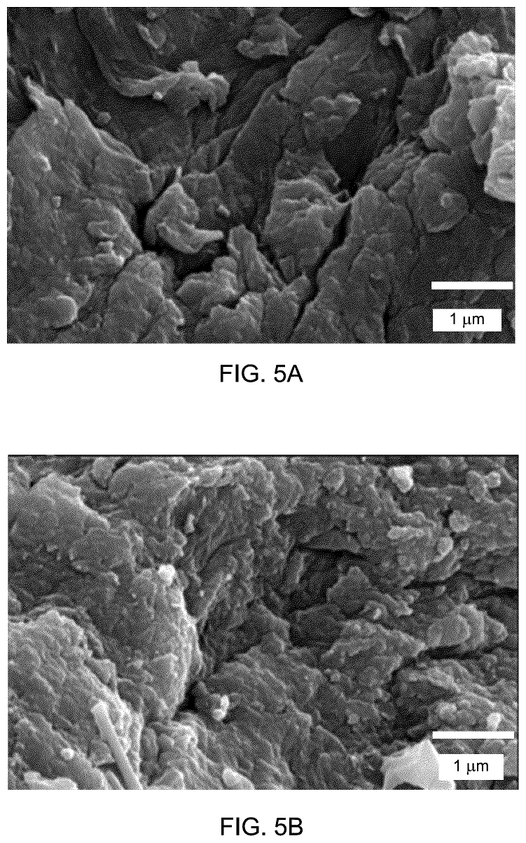

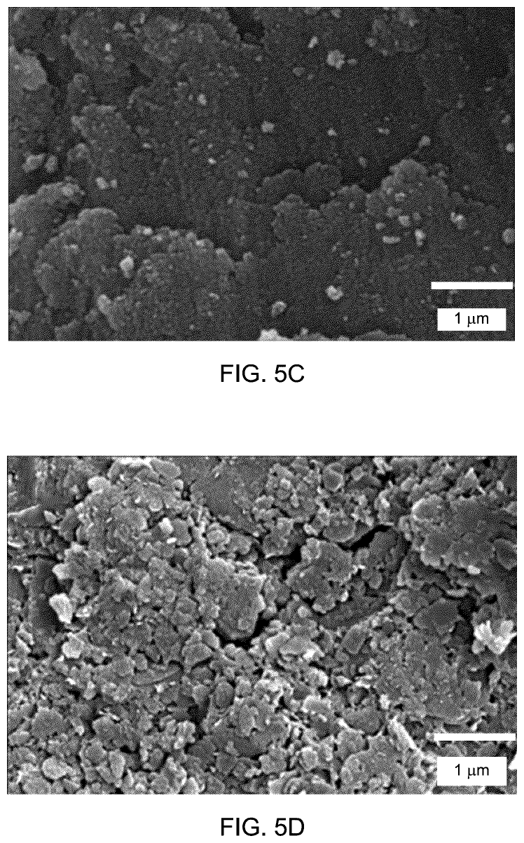

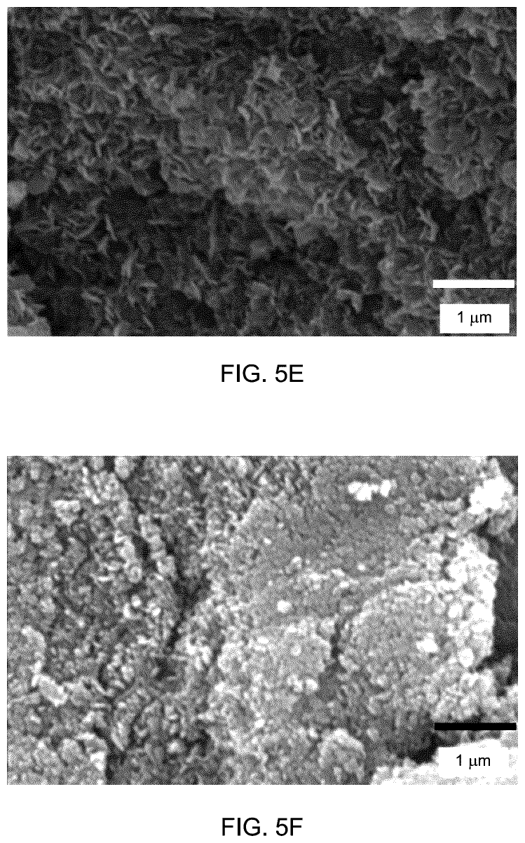

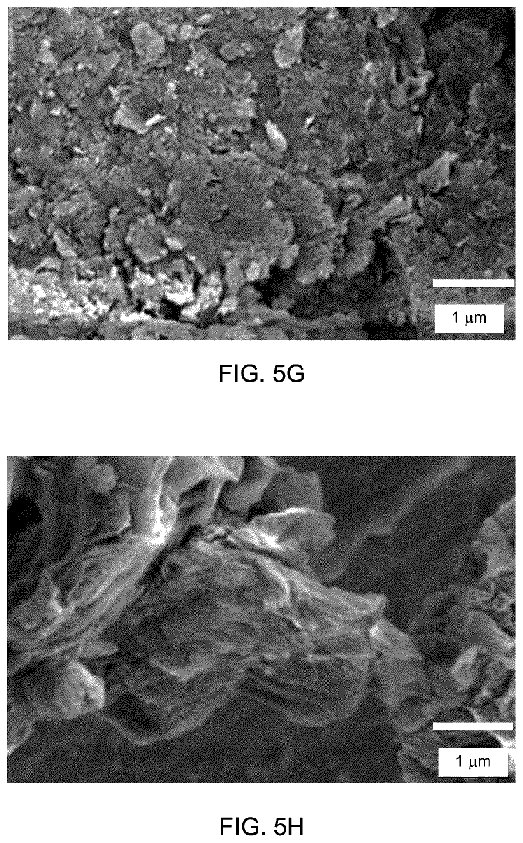

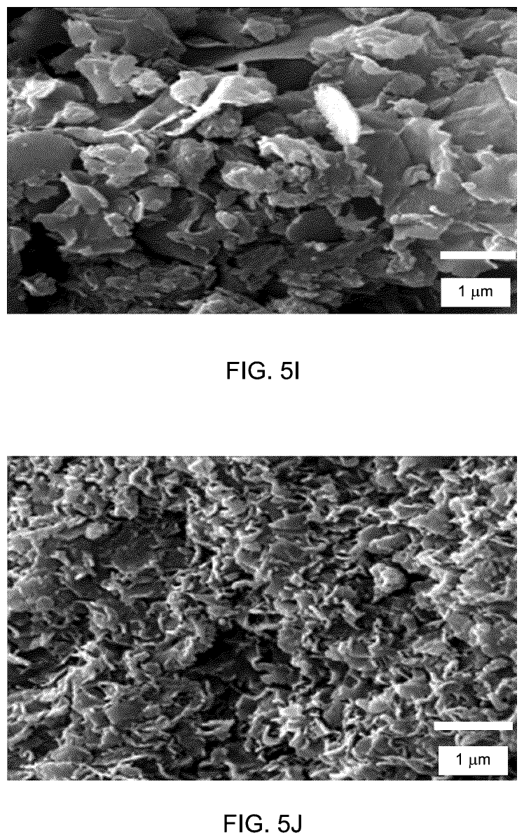

FIG. 5A illustrates the SEM of GO, presenting a compact, flake-like structure of varying sizes. FIG. 5B compares the functionalized graphene oxide (AGO) SEM with the GO, which exhibits fewer layers and a more irregular arrangement of differently sized flakes. In FIG. 5C, the surface of MgFeAl-LTH is shown to consist of tightly arranged, consistently sized nanoparticles, ranging between 20 to 40 nanometers. The SEM image for Bentonite (FIG. 5D) displays a densely packed surface of coarse microparticles. Remarkably, when GO is integrated with MgFeAl-LTH, as seen in FIG. 5E, the resulting surface morphology transforms into uniform nanosheets with a narrow size and thickness distribution. Furthermore, the SEM image in FIG. 5F of AGO/MgFeAl-LTH shows the AGO sheets strategically anchored to the MgFeAl-LTH structure. The Bentonite/MgFeAl-LTH morphology (FIG. 5G) is characterized by the appearance of bentonite particles with a stone-like quality firmly attached to MgFeAl-LTH sheets.

The texture of the GO/Bentonite surface (FIG. 5H) is relatively smooth, though marked with some fissures. This texture likely results from separating Bentonite layers upon GO addition and its subsequent intercalation within the Bentonite [S. Yang, N. Okada, M. Nagatsu, The highly effective removal of Cs+ by low turbidity chitosan-grafted magnetic bentonite, J. Hazard. Mater. 301 (2016), incorporated herein by reference in its entirety]. FIG. 5I depicts the morphology of the AGO/Bentonite composite, which shows a pronounced, rugged, and clustered structure. This indicates that the functionalization of graphene oxide with PEI fosters clustering due to the interaction between the amine groups of PEI and Bentonite, forming a stratified and intricate composite network. Lastly, the morphology of the AGO/Bentonite/MgFeAl-LTH nanocomposite shown in FIG. 5J exhibits a richly textured surface featuring dense, unevenly layered patterns. This morphology signifies a complex and multi-faceted composite where the MgFeAl-LTH intercalation into the AGO/Bentonite base seems to enhance a robust and tangled surface, indicative of significant intercomponent engagement.

Table 2 displays the elemental compositional analysis for all synthesized materials in this study. GO shows a high carbon content (64.30 atomic %) and a C/O ratio of 1.80, which is slightly close to the lower limit of the typical range (1.5-2.5) found in the literature [M. P. Aradjo, O. S. G. P. Soares, A. J. S. Fernandes, M. F. R. Pereira, C. Freire, Tuning the surface chemistry of graphene flakes: new strategies for selective oxidation, RSC Adv. 7 (2017), incorporated herein by reference in its entirety]. This indicates a more oxidized material with more functional groups on the surface. AGO, which is GO functionalized with PEI, displays an increased carbon percentage (66.20 atomic %) and a higher C/O ratio of 3.33, indicating a successful functionalization with the carbon-rich PEI, which reduces the oxygen content proportionally. The C/N ratio of 4.76 for AGO is a direct result of PEI functionalization, with this ratio giving insights into the degree of functionalization; the higher carbon relative to nitrogen indicates a substantial PEI presence, with carbon still being the dominant element. [H. Liu, Y. Zhou, Y. Yang, K. Zou, R. Wu, K. Xia, S. Xie, Synthesis of polyethylenimine/graphene oxide for the adsorption of U(VI) from aqueous solution, Appl. Surf. Sci. 471 (2019) 88-95, incorporated herein by reference in its entirety].

Bentonite's composition includes significant percentages of silicon (62.94%) and aluminum (23.35%), with a minor presence of iron (4.89%), which is typical of its clay mineral structure. The elemental ratios are not directly indicated for Bentonite alone; however, these would be expected to shift when composites are formed. The EDS data for MgFeAl-LTH in Table 2 shows that the ratios of (Al/Fe=3.71) and (Mg/(Al+Fe)=1.97) align with the synthesis ratios (Mg/(Fe+Al) ratio of 2 and Al/Fe ratio of 4), confirming the intended material composition.

GO/MgFeAl-LTH and AGO/MgFeAl-LTH composites exhibit variations in elemental composition that reflect the combination of GO or AGO with the MgFeAl-LTH structure. A notable point is a decrease in the C/N ratio of 8.80 of AGO/MgFeAl-LTH compared to GO/MgFeAl-LTH, indicating higher nitrogen than carbon due to the presence of PEI in the AGO. Moreover, the EDS data for Bentonite/MgFeAl-LTH shows the mixing of the main elements of Bentonite (i.e., Si, Fe, Al, Na, and Ca) with MgFeAl-LTH characteristic precursors (i.e., Mg, Fe, and Al), indicating the successful formation of this composite. In the GO/Bentonite and AGO/Bentonite composites, it can be observed that GO/Bentonite shows a C/O ratio closer to the standard for GO, implying less disruption of the GO structure, while AGO/Bentonite shows a C/N ratio closer to the standard for AGO, implying less disruption of the AGO structure as provided in Table 2.

Finally, the AGO/Bentonite/MgFeAl-LTH nanocomposite reveals a complex interplay of elements, with a substantial decrease in carbon content (13.89 atomic %) and an increase in silicon (29.39 atomic %) and magnesium (13.40 atomic %). The C/O ratio (0.26) is significantly lower than all samples, indicating extensive oxidation or more significant interaction between components that affect the carbon structure. The Mg/(Fe+Al) ratio of 1.47 is closer to the theoretical value for MgFeAl-LTH, indicating that the MgFeAl-LTH sample maintains its structure within the composite. The Al/Fe ratio is also increased compared to the synthesized MgFeAl-LTH, showing the influence of the other components and possibly the complex interactions at the interfaces of the combined materials.

TABLE 2
EDS of the synthesized composites and their parental materials.

| | | | | | | | | | | AGO/ |
|---|---|---|---|---|---|---|---|---|---|---|
| Adsorbent | | | | | GO/ | AGO/ | Bentonite/ | | | Bentonite/ |
| atomic | | | | MgFeAl- | MgFeAl- | MgFeAl- | MgFeAl- | GO/ | AGO/ | MgFeAl- |
| percentage | GO | AGO | Bentonite | LTH | LTH | LTH | LTH | Bentonite | Bentonite | LTH |
| C % | 64.30 | 66.20 | — | 22.90 | 39.20 | 22.00 | 31.13 | 56.70 | 37.58 | 13.89 |
| O % | 35.70 | 19.90 | — | 52.20 | 43.40 | 51.40 | 54.04 | 36.40 | 44.12 | 53.22 |
| N % | — | 13.90 | — | 5.30 | 2.80 | 2.50 | — | — | 6.37 | 3.24 |
| Mg % | — | — | 3.34 | 13.00 | 9.90 | 15.70 | 7.69 | 0.18 | 0.30 | 13.40 |
| Al % | — | — | 23.35 | 5.20 | 3.90 | 6.80 | 3.78 | 1.30 | 2.43 | 7.86 |
| Fe % | — | — | 4.89 | 1.40 | 0.80 | 1.60 | 1.02 | 0.31 | 0.26 | 1.29 |
| Si % | — | — | 62.94 | — | — | — | 2.22 | 4.64 | 8.27 | 6.53 |
| Na % | — | — | 4.16 | — | — | — | 0.00 | 0.25 | 0.16 | 0.41 |
| K % | — | — | 0.45 | — | — | — | 0.04 | 0.07 | 0.37 | 0.00 |
| Ca % | | — | 0.87 | — | — | — | 0.09 | 0.15 | 0.14 | 0.15 |
| C/O | 1.80 | 3.33 | — | 0.44 | 0.90 | 0.43 | 0.58 | 1.56 | 0.85 | 0.26 |
| C/N | — | 4.76 | — | 4.32 | 14.00 | 8.80 | — | — | 5.90 | 4.28 |
| Al/Fe | — | — | 4.78 | 3.71 | 4.88 | 4.25 | 3.70 | 4.14 | 9.39 | 6.12 |
| Mg/(Fe + Al) | — | — | 0.12 | 1.97 | 2.11 | 1.87 | 1.60 | 0.11 | 0.11 | 1.47 |

### Example 7: Adsorbent Screening

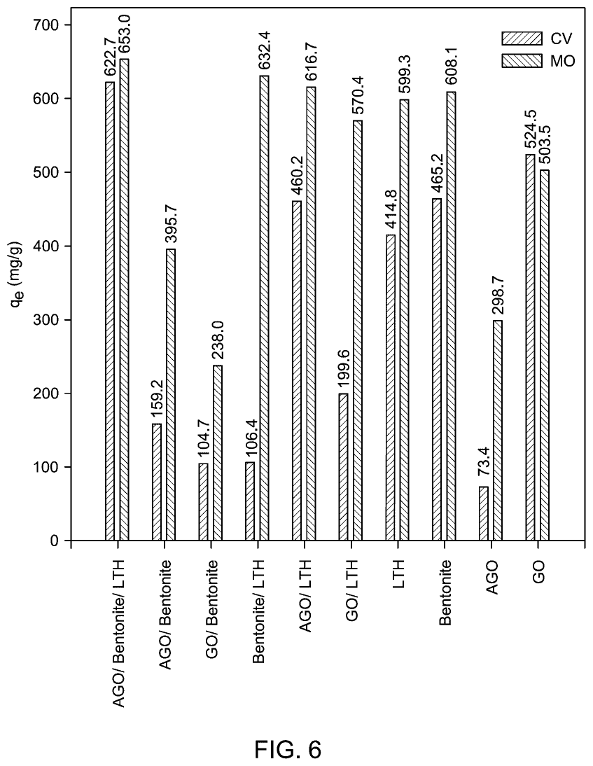

Preliminary experiments were conducted in order to compare the CV and MO adsorption performance of the synthesized nanocomposite (i.e., AGO/Bentonite/MgFeAl-LTH) to its simpler adsorbents (GO/MgFeAl-LTH, AGO/MgFeAl-LTH, Bentonite/MgFeAl-LTH, GO/Bentonite, AGO/Bentonite, GO, AGO, Bentonite, and MgFeAl-LTH). FIG. 6 shows the adsorption of CV and MO onto the AGO/Bentonite/MgFeAl-LTH nanocomposite and the pristine materials. According to the results presented in FIG. 6, the CV and MO adsorption capacity on the AGO/Bentonite/MgFeAl-LTH nanocomposite at the given experimental conditions is 622.7 and 653.0 mg/g, respectively which is superior to all parental materials.

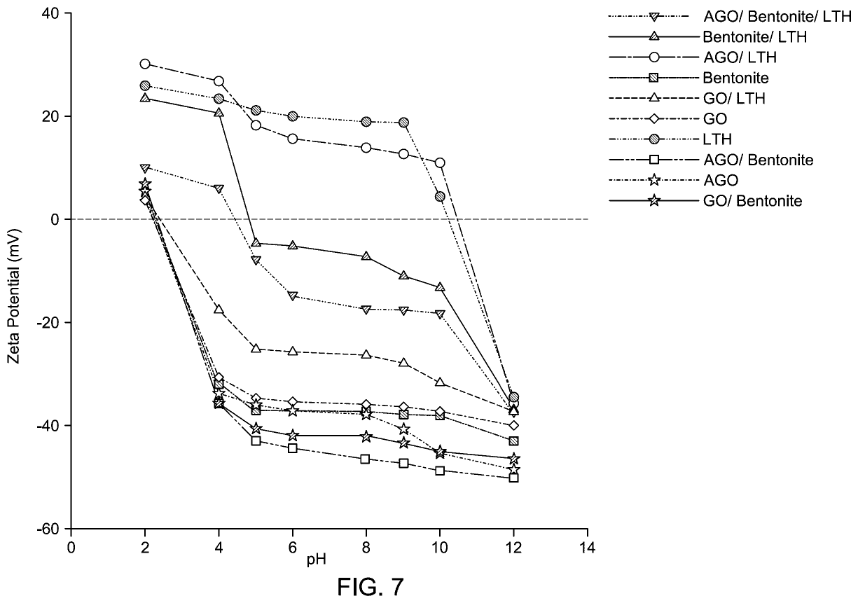

To delve deeper into the superior performance of the AGO/Bentonite/MgFeAl-LTH nanocomposite, we assessed zeta potential measurements across varying pH levels to reveal the charge on the synthesized materials at pH 6 (at which the results presented in FIG. 6 were obtained). FIG. 7 shows the obtained results from the zeta potential measurements, while Table 3 shows the point of zero charges (pHPZC) and the values of zeta potential obtained at pH 6 of all synthesized adsorbents of the present disclosure. According to the results presented in FIG. 7 and Table 3, MgFeAl-LTH and AGO/MgFeAl-LTH are positively charged, while the remaining eight adsorbents bear a negative charge at pH 6.

If the dominant factor in adsorption was the positive charge on the surface, the highest MO adsorption (anionic dye) on the AGO/MgFeAl-LTH and MgFeAl-LTH at pH 6 was observed. However, the results in FIG. 6 indicated that the AGO/Bentonite/MgFeAl-LTH nanocomposite exceptional MO adsorption could not be interpreted by electrostatic attraction forces alone. Other mechanisms, such as π-π interactions, H-bonding, and pore filling, may enhance MO adsorption on the AGO/Bentonite/MgFeAl-LTH nanocomposite. Similar observations regarding anionic dye adsorption by varied LDH composites have been documented in these studies [S. Lei, S. Wang, B. Gao, Y. Zhan, Q. Zhao, S. Jin, G. Song, X. Lyu, Y. Zhang, Y. Tang, Ultrathin dodecyl-sulfate-intercalated Mg—Al layered double hydroxide nanosheets with high adsorption capability for dye pollution, J. Colloid Interface Sci. 577 (2020) 181-190; and Y. Qiao, Q. Li, H. Chi, M. Li, Y. Lv, S. Feng, R. Zhu, K. Li, Methyl blue adsorption properties and bacteriostatic activities of Mg—Al layer oxides via a facile preparation method, Appl. Clay Sci. 163 (2018), each of which is incorporated herein by reference in its entirety].

In the case of CV adsorption, as shown in FIG. 7, the net charge on the AGO/Bentonite/MgFeAl-LTH, AGO/Bentonite, GO/Bentonite, Bentonite/MgFeAl-LTH, GO/MgFeAl-LTH, Bentonite, AGO, and GO is negative; while the net charge on MgFeAl-LTH and AGO/MgFeAl-LTH is positive at pH 6. Therefore, electrostatic attraction and high adsorption capacities are expected to take place for the removal of CV (a cationic dye) on the aforementioned eight adsorbents, while the opposite scenario is expected to occur for the latest two adsorbents. However, FIG. 7 reveals mixed trends, indicating that various adsorption mechanisms might explain the superiority of CV adsorption on the AGO/Bentonite/MgFeAl-LTH nanocomposite.

TABLE 3
Point of zero charge (pHPZC) of the synthesized
composites, their parental materials, and their
zeta potential values obtained at pH 6.

| Material | pH_{PZC} | Zeta potential at pH 6 (mV) |
|---|---|---|
| GO | 2.2 | −35.5 |
| AGO | 2.4 | −37.2 |
| Bentonite | 2.1 | −37.3 |
| MgFeAl-LTH | 10.1 | 20.1 |
| GO/MgFeAl-LTH | 2.5 | −25.9 |
| AGO/MgFeAl-LTH | 10.6 | 15.6 |
| Bentonite/MgFeAl-LTH | 2.8 | −5.3 |
| GO/Bentonite | 2.3 | −41.8 |
| AGO/Bentonite | 2.2 | −44.4 |
| AGO/Bentonite/MgFeAl-LTH | 4.5 | −15.0 |

### Example 8: Effect of pH

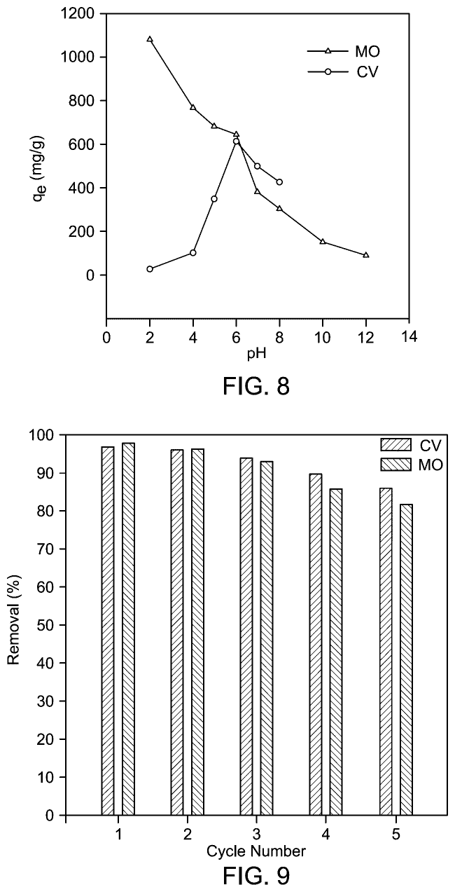

The pH level of the adsorption environment plays a crucial role in modifying the ionization levels of both adsorbents and adsorbates, thereby influencing the adsorption process. Table 4 and FIG. 8 illustrate how pH impacts the adsorption of CV and MO when using the AGO/Bentonite/MgFeAl-LTH nanocomposite. The data in Table 4 and FIG. 8 reveal that the CV adsorption capacity increases from 47.1 to 622.7 mg/g when pH increases from 2 to 6. This trend drops to 439.2 mg/g as pH reaches 8.

FIG. 7 shows that the AGO/Bentonite/MgFeAl-LTH nanocomposite holds a net positive charge at pH levels of 2 and 4. Given the cationic nature of CV at these pH ranges, there is an anticipated electrostatic repulsion, especially at pH 2 and, to a lesser extent, at pH 4. This observation aligns with the data in FIG. 8 and Table 4, where CV adsorption is at its lowest at pH 2, followed by pH 4. As the pH level of the adsorption environment escalates to 6, the charge on the AGO/Bentonite/MgFeAl-LTH nanocomposite becomes negative, fostering an electrostatic attraction with CV, leading to increased CV adsorption. One might expect this trend to persist with further pH elevation. However, contrary to this assumption, FIG. 8 shows a reduction in CV adsorption when pH shifts from 6 to 8. This indicates that other mechanisms influence CV adsorption on the AGO/Bentonite/MgFeAl-LTH nanocomposite beyond mere electrostatic interaction. Interactions such as π-π stacking, complexation, coordination, hydrophobic interactions, and/or H-bonding likely play pivotal roles in this process [S. A. Bahadi, M. Iddrisu, M. K. Al-Sakkaf, M. A. A. Elgzoly, Q. A. Drmosh, W. A. Al-Amrani, U. Ahmed, U. Zahid, S. A. Onaizi, Optimization of methyl orange adsorption on MgFeAl-LTH through the manipulation of solution chemistry and synthesis conditions, Emergent Mater. (2023); S. A. Ganiyu, M. A. Suleiman, W. A. Al-Amrani, A. K. Usman, S. A. Onaizi, Adsorptive removal of organic pollutants from contaminated waters using zeolitic imidazolate framework Composites: A comprehensive and Up-to-date review, Sep. Purif. Technol. 318 (2023); and S. A. Bahadi, M. Iddrisu, M. K. Al, S. Mohammed, W. Ahmed, A. Amrani, U. Ahmed, U. Zahid, Q. A. Drmosh, S. A. Onaizi, Chemically versus thermally reduced graphene oxide: effects of reduction methods and reducing agents on the adsorption of phenolic compounds from wastewater, (2023), each of which is incorporated herein by reference in its entirety].

The adsorption capacity of MO on the AGO/Bentonite/MgFeAl-LTH nanocomposite consistently decreases as the pH increases. Specifically, MO adsorption dropped sharply from 1084.0 mg/g to just 106.0 mg/g as the adsorption medium pH increased from 2 to 12. As MO is an anionic dye, this behavior, as illustrated in FIG. 8, primarily indicates electrostatic interaction as the main driver behind this trend. Nevertheless, other mechanisms may also be crucial.

TABLE 4
Adsorption capacities of the AGO/Bentonite/MgFeAl-
LTH nanocomposite for removing CV and
MO at different pH values.

qₑ (mg/g)

| pH | CV | MO |
|---|---|---|
| 2 | 47.1 | 1084.0 |
| 4 | 116.6 | 777.8 |
| 5 | 358.7 | 692.3 |
| 6 | 622.7 | 653.0 |
| 7 | 506.7 | 395.1 |
| 8 | 439.2 | 318.5 |
| 10 | — | 166.6 |
| 12 | — | 106.0 |

### Example 9: Regeneration Studies

Adsorbent reusability is crucial for effective wastewater treatment. The capacity for the AGO/Bentonite/MgFeAl-LTH nanocomposite to regenerate after adsorbing CV and MO over five continuous cycles was investigated. The used adsorbent was regenerated with a 0.2 M NaOH aqueous solution. After this process, the adsorbent was rinsed several times with distilled water to eliminate any residual NaOH before drying. Notably, the nanocomposite color remained consistent throughout these cycles, affirming its stability. The performance of this regenerated adsorbent is illustrated in FIG. 9.

The removal rates of CV and MO by a freshly prepared AGO/Bentonite/MgFeAl-LTH nanocomposite stood at 96.5% and 97.5%, respectively. By the fifth cycle, the adsorbent still demonstrated significant removal rates, though there was a minor decrease. The rates dropped to 85.7% for CV and 81.5% for MO, as shown in FIG. 9. This means that after five cycles of adsorption and desorption, the removal efficiency for CV and MO decreased by just 11.2% and 16.4%, respectively, compared to the fresh nanocomposite. These results indicate the nanocomposite shows consistent performance and durability, positioning it as a reliable option for water purification applications.

Numerous modifications and variations of the present invention are possible in light of the above teachings. It is therefore to be understood that within the scope of the appended claims, the invention may be practiced otherwise than as specifically described herein.

1. A nanocomposite sorbent, comprising:
a carbon nanomaterial polymer composite comprising polyethyleneimine and a carbon nanomaterial;
a smectite clay; and
a layered triple hydroxide comprising a first metal, a second metal, and a third metal.

2. The nanocomposite sorbent of claim 1, wherein the carbon nanomaterial is graphene oxide.

3. The nanocomposite sorbent of claim 1, wherein the carbon nanomaterial polymer composite has a weight ratio of polyethyleneimine to carbon nanomaterial of 1:5 to 1:15.

4. The nanocomposite sorbent of claim 1, wherein the smectite clay is bentonite.

5. The nanocomposite sorbent of claim 1, having a weight ratio of the carbon nanomaterial polymer composite to the smectite clay of 2.5:1 to 1:2.5.

6. The nanocomposite sorbent of claim 1, wherein the first metal is magnesium, the second metal is iron, and the third metal is aluminum.

7. The nanocomposite sorbent of claim 1, having
a surface area of 68 to 115 m²/g;
a pore volume of 0.15 to 0.40 cm³/g; and
a pore size of 7.0 to 17.0 nm.

8. The nanocomposite sorbent of claim 1, having a composition that includes
12.5 to 15 atom % carbon,
12.5 to 15.0 atom % the first metal
5.0 to 10.0 atom % the second metal
0.25 to 2.5 atom % the third metal,
4.0 to 9.0 atom % silicon,
a ratio of the first metal to a total of the second metal and the third metal of 1.00:1 to 2.00:1 by atom %, and
a ratio of carbon to nitrogen of 3.5:1 to 5.0:1 by atom %.

9. The nanocomposite sorbent of claim 1, wherein the layered triple hydroxide is present as particles having a mean particle size of 10 to 50 nm.

10. The nanocomposite sorbent of claim 1, wherein the carbon nanomaterial is graphene oxide and is present as flakes having 2 to 10 layers of graphene oxide.

11. A method of forming the nanocomposite sorbent of claim 1, the method comprising
dispersing the carbon nanomaterial polymer composite and smectite clay in water to form a first mixture;
adding to the first mixture a base solution comprising a base mixture and a metal solution comprising the first metal, the second metal, and the third metal to form a reaction mixture;
aging the reaction mixture for 8 to 36 hours to form a crude product; and
washing the crude product to form the nanocomposite sorbent.

12. The method of claim 11, further comprising forming the carbon nanomaterial polymer composite by:
mixing the carbon nanomaterial, a base, and the polyethyleneimine in water to form a precursor mixture, and
heating the precursor mixture to 75 to 105° C. for 12 to 48 hours to form the carbon nanomaterial polymer composite.

13. The method of claim 11, wherein the first metal, the second metal, and the third metal are each present as a salt selected from a nitrate salt, a sulfate salt, a halide salt, an acetate salt, and a formate salt.

14. The method of claim 11, wherein the first metal is magnesium, the second metal is iron, and the third metal is aluminum.

15. The method of claim 14, wherein the metal solution comprises magnesium nitrate, iron (III) nitrate, and aluminum nitrate.

16. The method of claim 11, wherein the base mixture comprises an alkali metal or alkaline earth metal carbonate and an alkali metal or alkaline earth metal hydroxide.

17. The method of claim 11, wherein the base solution, the metal solution are each an aqueous solution.

18. A method of removing an organic pollutant from water comprising:
contacting water containing an organic pollutant with the nanocomposite sorbent of claim 1;
recovering the nanocomposite sorbent; and
optionally eluting the organic pollutant from the nanocomposite sorbent,
wherein the organic pollutant is at least one selected from the group consisting of a dye, a phenol, a polycyclic aromatic hydrocarbon, an herbicide, a pesticide, and a persistent organic pollutant.

19. The method of claim 18, further comprising eluting the organic pollutant from the nanocomposite sorbent by washing with a wash solvent.

20. The method of claim 18, wherein the method removes
750 to 1100 mg methyl orange per gram of nanocomposite sorbent at a pH of 2 to 4; and
425 to 650 mg crystal violet per gram of nanocomposite sorbent at a pH of 6 to 8.
